(19) United States
(12) Patent Application Publication
(10) Pub. No.: US 2026/0180871 A1
(43) Pub. Date: Jun. 25, 2026

(54) ARTIFICIAL INTELLIGENCE-BASED WI-FI MESH CONFIGURATION

(71) Applicant: QUALCOMM Incorporated, San Diego, CA (US)

(72) Inventor: Xiaolong HUANG, Santee, CA (US)

(21) Appl. No.: 18/999,765

(22) Filed: Dec. 23, 2024

(51) Int. Cl. H04L 41/16; H04W 24/02

(52) U.S. Cl. CPC H04L 41/16; H04W 24/02

(57) ABSTRACT

This disclosure provides methods, components, devices and systems for artificial intelligence-based Wi-Fi mesh configuration. Some aspects more specifically relate to determining a set of operating parameters based on an output of a machine learning (ML) model. In some examples, the AP may receive one or more reports from one or more different APs. In such examples, the reports may include an indication of a set of configuration parameters utilized by the different APs. In some examples, the AP may input the set of configuration parameters associated with the different APs, a set of current local operating parameters associated with the AP, or both into the ML model. In some examples, the AP may receive a set of outputs of the ML model including a set of updated operating parameters, and the AP may apply the set of updated parameters to perform wireless communications.

### TECHNICAL FIELD

This disclosure relates generally to wireless communication and, more specifically, to artificial intelligence-based Wi-Fi mesh configuration.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure may be implemented in a method for wireless communications by a first access point (AP). The method may include receiving a first report from a second AP served by the first AP, the first report including a first set of multiple parameters associated with the second AP, inputting a set of multiple inputs including the first set of multiple parameters, a set of multiple current local parameters including a current configuration of the first AP, or both into a machine learning (ML) model, receiving a set of multiple outputs of the ML model, the set of multiple outputs including a set of multiple updated local parameters for the first AP, and performing wireless communications with the second AP, a third AP that serves the first AP, one or more stations (STAs), or any combination thereof, in accordance with the set of multiple updated local parameters for the first AP.

Another innovative aspect of the subject matter described in this disclosure can be implemented in a first AP for wireless communications. The first AP may include a processing system that includes processor circuitry and memory circuitry that stores code. The processing system may be configured to cause the first AP to receive a first report from a second AP served by the first AP, the first report including a first set of multiple parameters associated with the second AP, input a set of multiple inputs including the first set of multiple parameters, a set of multiple current local parameters including a current configuration of the first AP, or both into an ML model, receive a set of multiple outputs of the ML model, the set of multiple outputs including a set of multiple updated local parameters for the first AP, and perform wireless communications with the second AP, a third AP that serves the first AP, one or more STAs, or any combination thereof, in accordance with the set of multiple updated local parameters for the first AP.

Another innovative aspect of the subject matter described in this disclosure can be implemented in a first AP for wireless communications. The first AP may include means for receiving a first report from a second AP served by the first AP, the first report including a first set of multiple parameters associated with the second AP, means for inputting a set of multiple inputs including the first set of multiple parameters, a set of multiple current local parameters including a current configuration of the first AP, or both into an ML model, means for receiving a set of multiple outputs of the ML model, the set of multiple outputs including a set of multiple updated local parameters for the first AP, and means for performing wireless communications with the second AP, a third AP that serves the first AP, one or more STAs, or any combination thereof, in accordance with the set of multiple updated local parameters for the first AP.

Another innovative aspect of the subject matter described in this disclosure can be implemented in a first AP that includes non-transitory computer-readable medium storing code for wireless communications is described. The code may include instructions executable by one or more processors to receive a first report from a second AP served by the first AP, the first report including a first set of multiple parameters associated with the second AP, input a set of multiple inputs including the first set of multiple parameters, a set of multiple current local parameters including a current configuration of the first AP, or both into an ML model, receive a set of multiple outputs of the ML model, the set of multiple outputs including a set of multiple updated local parameters for the first AP, and perform wireless communications with the second AP, a third AP that serves the first AP, one or more STAs, or any combination thereof, in accordance with the set of multiple updated local parameters for the first AP.

Some examples of the method, first APs, and non-transitory computer-readable medium described herein may further include operations, features, means, or instructions for receiving, from the third AP, a second report including a second set of multiple parameters associated with the third AP, where the set of multiple outputs of the machine learning model are based at least in part on the second set of multiple parameters, receiving, from the third AP, an indication of a traffic pattern associated with the third AP, an indication of one or more performance metrics associated with a set of multiple previous parameters, or both, the traffic pattern based on the current configuration of the first AP and applying a reward function based on the traffic pattern, the one or more performance metrics, a satisfaction of a target time threshold, or a combination thereof, where receiving the set of multiple updated local parameters may be based on the reward function.

Some examples of the method, first APs, and non-transitory computer-readable medium described herein may further include operations, features, means, or instructions for outputting to the second AP, the third AP, or both, an updated configuration report including the set of multiple updated local parameters, an indication of one or more performance metrics associated with the set of multiple updated local parameters, or a combination thereof.

Some examples of the method, first APs, and non-transitory computer-readable medium described herein may further include operations, features, means, or instructions for determining the set of multiple inputs to the ML model in accordance with the first set of multiple parameters, the second set of multiple parameters, the set of multiple current local parameters, or any combination thereof, where the set of multiple inputs includes one or more system topology parameters, one or more traffic parameters, one or more channel parameters, or any combination thereof, and where the set of multiple inputs to the ML model may be associated with a mesh network including at least the first AP, the second AP, and the third AP.

Some examples of the method, first APs, and non-transitory computer-readable medium described herein may further include operations, features, means, or instructions for encoding the set of multiple inputs to the ML model according to one or more parameter types, where each input of the set of multiple inputs to the ML model may be associated with a respective device identifier (ID) or traffic flow ID corresponding to a network topology of the mesh network.

Some examples of the method, first APs, and non-transitory computer-readable medium described herein may further include operations, features, means, or instructions for encoding the set of multiple inputs to the ML model according to a network topology hierarchy mapping, where the set of multiple inputs to the ML model may be associated with one or more hops of the mesh network, and where a relative position of the set of multiple inputs within the mesh network with respect to each other input of the set of multiple inputs may be determined based on the network topology hierarchy mapping and the one or more hops of the mesh network.

In some examples of the method, first APs, and non-transitory computer-readable medium described herein, the one or more system topology parameters include a backhaul client association, a fronthaul client association, a pathloss value for each of the backhaul client association, the fronthaul client association, one or more interfering basic service sets (BSSs) for each BSS of the mesh network, or any combination thereof.

In some examples of the method, first APs, and non-transitory computer-readable medium described herein, the one or more channel parameters include one or more channel numbers for each AP multi-link device of the mesh network, a channel bandwidth for each BSS, a channel access delay for each BSS, an airtime of one or more overlapping BSSs for each BSS, or any combination thereof.

Some examples of the method, first APs, and non-transitory computer-readable medium described herein may further include operations, features, means, or instructions for generating a reward function output for the ML model based on a performance impact associated with a set of multiple previous outputs of the ML model, a satisfaction of a target time threshold, or both and adjusting one or more parameters for inputting into the ML model in accordance with the reward function output.

Some examples of the method, first APs, and non-transitory computer-readable medium described herein may further include operations, features, means, or instructions for measuring the performance impact based on applying the set of multiple updated local parameters, the performance impact associated with a performance of a mesh network including at least the first AP, the second AP, the third AP, and one or more STAs, where generating the reward function output may be based on measuring the performance impact.

In some examples of the method, first APs, and non-transitory computer-readable medium described herein, the target time threshold includes a timing for determining, in accordance with the ML model, the set of multiple updated local parameters based on the inputting.

Some examples of the method, first APs, and non-transitory computer-readable medium described herein may further include operations, features, means, or instructions for sampling a set of multiple candidate communication configurations corresponding to a set of multiple candidate outputs of the ML model for the first AP during a training stage for the ML model, selecting a subset of the set of multiple candidate communication configurations based on the sampling and based on one or more performance metrics corresponding to the set of multiple candidate communication configurations, and updating the ML model in accordance with the subset of the set of multiple candidate communication configurations, where receiving the set of multiple updated local parameters may be based on updating the ML model.

Details of one or more implementations of the subject matter described in this disclosure are set forth in the accompanying drawings and the description below. Other features and aspects will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example of a flow diagram that illustrates inputting a set of parameters into a machine learning (ML) model and receiving a set of updated local parameters from the ML model that supports artificial intelligence-based Wi-Fi mesh configuration.

FIG. 4 shows an example of a flow diagram that illustrates selecting a set of updated local parameters for an AP based on an output of an autoencoder that supports artificial intelligence-based Wi-Fi mesh configuration.

FIG. 5 shows an example of a flow diagram that illustrates inputting a set of parameters into an ML model and receiving a set of updated local parameters from the ML model that supports artificial intelligence-based Wi-Fi mesh configuration.

FIG. 6 shows an example of a signaling diagram illustrating a distributed mesh network that supports artificial intelligence-based Wi-Fi mesh configuration.

FIG. 7 shows an example of a process flow that illustrates inputting a set of parameters into an ML model and receiving a set of updated local parameters from the ML model that supports artificial intelligence-based Wi-Fi mesh configuration.

FIG. 8 shows a block diagram of an example wireless communication device that supports artificial intelligence-based Wi-Fi mesh configuration.

FIGS. 9 through 13 show flowcharts illustrating example processes performable by or at a first access point (AP) that supports artificial intelligence-based Wi-Fi mesh configuration.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, an access point (AP) may be part of a mesh network (such as a distributed network including multiple APs). In such cases, the mesh network may perform communications according to a large quantity (such as hundreds or more) of operating parameters. Additionally, or alternatively, each traffic flow for each of the multiple APs may be associated with one or more operating parameters, one or more performance metrics, one or more service level agreements (SLAs), or any combination thereof. In such cases, the AP may adjust one or more of the multiple operating parameters (such as to balance one or more traffic loads) in accordance with attempting to satisfy one or more of the performance metrics, SLAs, or any combination thereof. For example, the AP may select one or more parameters in a fixed (such as static) manner to satisfy one or more communication metric thresholds (such as throughput, among other examples) based on a set of rules (such as heuristics). However, in such cases, one or more APs may experience a performance tradeoff associated with adjusting the one or more operating parameters (such as between traffic fairness and aggregate throughput, among other examples). For example, adjusting the one or more operating parameters to increase communication fairness (such as fairness of communicating via one traffic flow over another traffic flow) based on a rule that indicates a prioritization of communication fairness may relatively decrease a total throughput for the mesh network. Additionally, or alternatively, the AP may be unable to adjust the one or more operating parameters to benefit a different AP of the mesh network (because the AP may be unaware of the operating parameters of one or more operating conditions of the different AP), and adjusting the one or more operating parameters at one AP may negatively impact the performance of one or more other APs. For example, the AP may be unaware of a throughput threshold of a different AP of the mesh network and may (such as without coordination messages between APs) adjust one or more operating parameters to prioritize increase communication fairness based on a rule, which may negatively impact the throughput of the different AP (such as violating the throughput threshold of the different AP and negatively impacting overall network performance and coordination).

Various aspects relate generally to artificial intelligence (AI)-based mesh configurations. Some aspects more specifically relate to identifying and applying a set of operating parameters based on an output of a machine learning (ML) model. In some examples, the ML model may utilize or implement a supervised learning model, a reinforcement learning model, or both. In some examples, the AP may receive a report from a different AP serving the AP (such as an upstream AP), a report from a different AP that is served by the AP (such as a downstream AP), or both. In such examples, the report may include an indication of a set of configuration parameters utilized by the different APs (such as the upstream AP or the downstream AP), a traffic pattern associated with the upstream AP (such as a traffic pattern associated with a set of operating parameters utilized by the AP), or any combination thereof.

In some examples, the AP may input the set of configuration parameters associated with the different APs, a set of current local operating parameters associated with the AP, or a combination thereof into the ML model. In some examples, the AP may generate and select a reward function for training the ML model based on the traffic pattern of the upstream AP, a performance impact for the mesh network associated with the set local operating parameters (such as a set of previous local operating parameters), a target time threshold for updating the set of local operating parameters, or any combination thereof. In some examples, the AP may receive a set of outputs of the ML model including a set of updated local operating parameters. In such examples, the AP may apply the set of updated local parameters to perform wireless communications with the different APs (such as the upstream AP, the downstream AP, or both), one or more stations (STA) associated with the mesh network and the AP, or any combination thereof, in accordance with the set of updated parameters.

Such aspects of the subject matter described in this disclosure can be implemented to realize one or more of the following potential benefits. In some examples, by training the ML model with encoded operating parameters corresponding to multiple (such as hundreds or thousands) of sampled mesh network scenarios and by inputting a current set of local operating parameters associated with a current network scenario, the AP may receive the set of updated local operating parameters from the ML model corresponding to the set of current local operating parameters and the set of operating parameters associated with the different APs via one or more of the techniques described herein, which may enable the AP to efficiently identify the many (such as hundreds or more) of operating conditions associated with the AP, the mesh network, or both. Accordingly, applying the set of updated local operating parameters may benefit the performance of the AP, overall mesh network performance, or both. Additionally, or alternatively, by performing communications according to the set of updated local operating parameters generated by the ML model (such as the ML model trained according to multiple sampled network scenarios), the AP may perform wireless communications that satisfy multiple performance requirements, multiple SLAs, or any combination thereof (such as without performance tradeoffs between the requirements or SLAs). For example, the ML model may generate and output, and the AP may receive, a set of updated local operating parameters that satisfy a latency SLA, a throughput SLA, and a fairness requirement simultaneously, among other examples.

In some examples, the AP may output a report to the different AP (such as the upstream AP, the downstream AP, or both) including an indication of the set of updated local operating parameters, an indication of one or more performance metrics associated with the set of updated local operating parameters, or both.

Such aspects of the subject matter described in this disclosure can be implemented to realize one or more of the following potential benefits. In some examples, by outputting the report to the different AP indicating the set of updated local operating parameters, the one or more performance metrics, or both, via one or more of the techniques described herein, the AP may indicate to the different APs (such as one or more different upstream APs, downstream APs, or both), the set of updated local operating parameters utilized by the AP, as well as an indication of whether the set of updated local operating parameters are beneficial to communications at the AP (such as relatively improve the performance of the AP with regard to the one or more performance metrics, one or more SLAs, or both). Accordingly, the different APs may utilize the report to correspondingly select (such as generate via an ML model, among other examples) one or more different operating parameters based on the report (such as based on the indicated updated local parameters and the performance metrics). In such examples, each AP of the mesh network may select sets of operating parameters via one or more ML models in a coordinated manner (such as based on the reporting of the selected parameters between the APs). That is, each AP of the mesh network may generate a set of operating parameters via an output of an ML model based on configurations of the other APs (such as overall network scenarios), which may relatively improve the overall performance of the mesh network. The ML model may additionally identify (such as generate, among other examples) one or more updated operating parameters that may enable the AP to support a communication metric threshold and an overall performance of the different APs.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

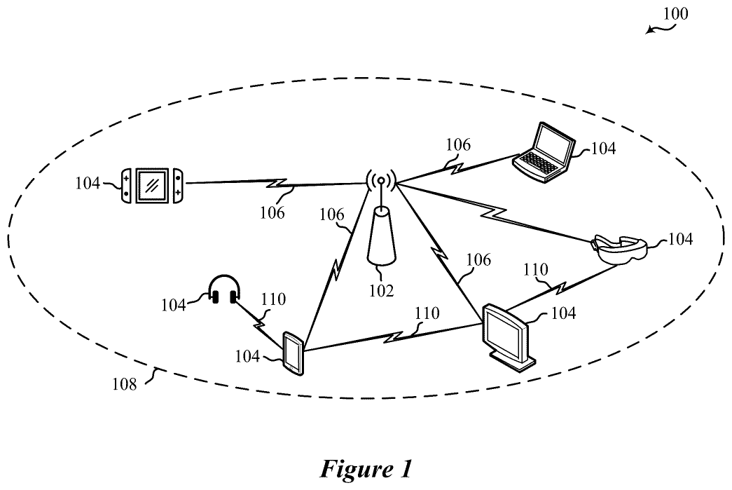

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHz), FR4a or FR4-1 (52.6 GHZ-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other benefits without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

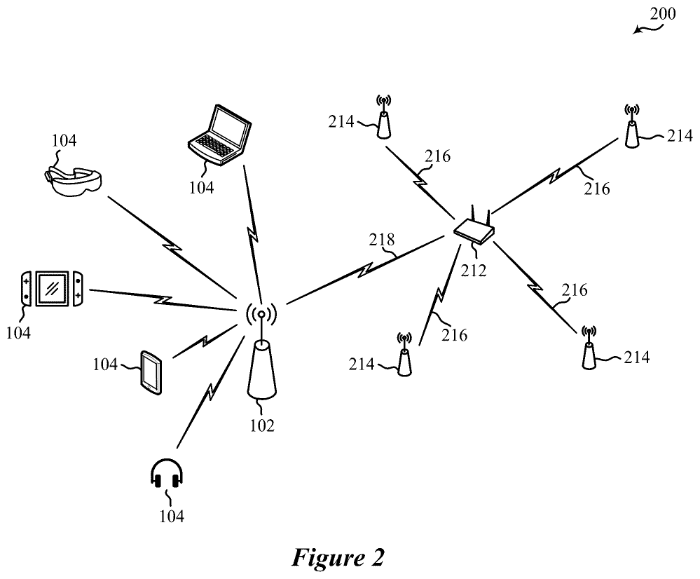

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

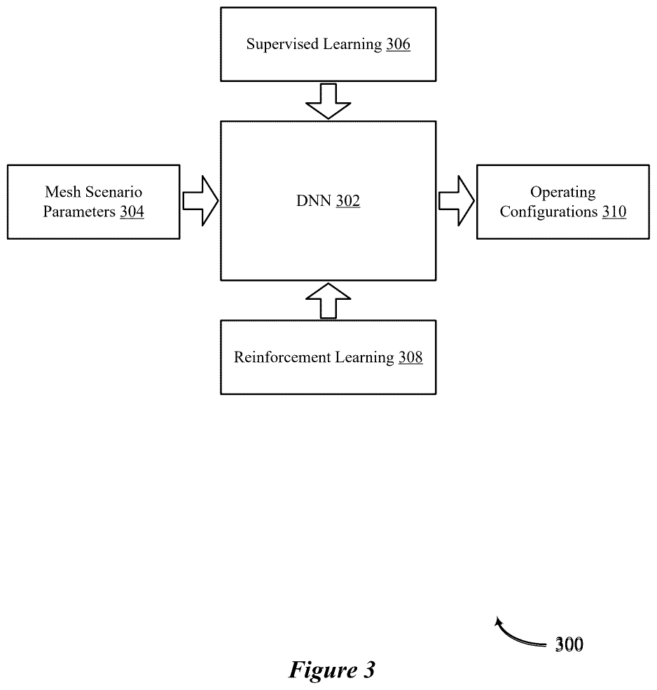

FIG. 3 shows an example of a flow diagram 300 that supports artificial intelligence-based Wi-Fi mesh configuration. In accordance with the block diagram 300, an AP 102 may utilize a deep neural network (DNN) 302 to obtain a set of updated local operation parameters. In some examples, the DNN 302 may be operated at the AP 102, at a cloud server, or at a controller device (such as a controller device for a mesh network) among other examples.

In some implementations, a configuration (such as a Wi-Fi mesh configuration) of the AP 102 may include a set of operating parameters associated with the AP 102 (such as, a set of operating parameters, operating settings, operating environments, or operating conditions, among other examples). In some examples, the set of operating parameters may include one or more aspects (such as within a feature set) of a mesh network scenario (such as one or more mesh network scenarios including at least each AP 102, among other APs 102 and other devices (such as one or more client STAs 104). For example, each configuration (such as, set of operating parameters) may include an indication of a network topology (such as a connection topology of a mesh network), an indication of an AP-to-STA association structure, a channel map and an indication of one or more channel conditions associated with the channel map, an indication of a traffic flow distribution over the network topology, an indication of a traffic demand, one or more SLAs of each traffic flow, or any combination thereof.

In some implementations, the AP 102 may input a set of mesh scenario parameters 304 (such as a set of local operating parameters, or operating parameters at another AP as indicated by an upstream AP, a downstream AP, or both) into the DNN 302, and the AP 102 may, via the DNN 302, obtain a set of operating parameters 310 (such as a set of updated local operating parameters) associated with wireless communications at the AP 102. In some examples, the DNN 302 may generate the set of operating parameters 310 based on performing supervised learning 306, reinforcement learning 308, or both. In some implementations, the AP 102 may input the set of mesh scenario parameters 304 into the DNN 302. In such implementations, the set of mesh scenario parameters 304 may include an indication of a mesh topology associated with a mesh network including at least the AP 102, one or more channel conditions of the mesh network, a traffic demand of the AP 102, or any combination thereof.

In some implementations, the DNN 302 may utilize a regression function trained using the supervised learning 306. In some examples, the AP 102 may sample various scenarios (such as mesh scenarios or mesh configurations associated with at least the AP 102) during the operation of the AP 102 (such as sample as many scenarios as possible over time). In some examples, the AP 102 may (such as via the DNN 302) define (such as determine or calculate, among other examples) an objective function for relatively improving the performance of the AP 102, the mesh, or both, while simultaneously satisfying one or more performance thresholds, SLAs, or both.

Additionally, or alternatively, the DNN 302 may generate multiple sets of operating parameters 310 (such as trying different configurations), and the AP 102 may identify, based on applying the multiple sets of operating parameters 310 (such as and based on the one or more performance metrics, the one or more SLAs, or any combination thereof) at least one set of operating parameters 310 that generates a greater performance improvement relative to the other sets of operating parameters 310 of the multiple sets of operating parameters 310 (such as a best-performing configuration for each scenario). Additionally, or alternatively, the AP 102 may train the DNN 302 (such as an artificial neural network (ANN)) with the identified set of operating parameters 310 for each of the sampled scenarios. Additionally, or alternatively, the AP 102 (such as via the DNN 302), may generate one or more additional sets of operating parameters 310 based on a scenario (such as an identified scenario) being significantly different (such as not resembling, or having most parameters of the set of operating parameters of the additional scenario differing) from the sampled scenarios.

Additionally, or alternatively, the DNN 302 may search for (such as learn to search for) the set of operating parameters 310 using the reinforcement learning 308. In some examples, the AP 102 may (such as via the DNN 302) define (such as determine or calculate, among other examples) an objective function for relatively improving the performance of the AP 102, the mesh, or both, while simultaneously satisfying one or more performance thresholds, SLAs, or both. In some examples, the AP 102 may define an episode (such as learning episode, or training episode). In such examples, the episode may include a series of configuration adjustments within a defined duration of time. For example, the episode may be defined to be a series of configuration adjustments within a few seconds (such as three seconds, for an example).

In some implementations, the AP 102 may define one or more states (such as operation states of the AP 102, the mesh, or both). In such examples, the one or more states may include a scenario (such as a current mesh scenario), a performance metric associated with the state, a remaining time (such as a duration of time remaining within the episode), and a current configuration (such as a configuration of the AP 102). Additionally, or alternatively, the AP 102 may define one or more actions including one or more configuration changes (such as changes to the configuration of the AP 102).

In some implementations, the AP 102 may define (such as identify, determine, or generate, among other examples) one or more reward functions for the DNN 302. In some examples, the reward function may be based on a weighted performance improvement. In such examples, the AP 102 may determine (such as calculate) a value of the weighted performance improvement based on a duration of time remaining within the episode (such as an amount of time remaining to perform a configuration change). For example, a reward based on a state determined at the beginning of an episode (such as with most of the episode duration remaining) may receive a greater weight than a reward based on a state determined at the end of an episode. Additionally, or alternatively, the weighted performance improvement may further be based on a relative magnitude of a performance impact associated with the state.

In some implementations, the objective function may include one or more sub-objective functions (such as, corresponding to one or more performance factors). For example, a sub-objective function may compare a communication fairness (such as a fairness of resource allocations between one or more communication flows) with a capacity (such as communication capacity, or communication volume) of the mesh. In such examples, the sub-objective function may be given by Equation 1, shown below.

$$h ( λ ) = {\sum }_{i} {G}_{i} log \frac{{λ}_{i}}{max {r}_{i}} \qquad ( 1 )$$

In such examples, Gᵢ may be defined to be a greater value for MU-capable device (such as MU capable APs 102). In such examples, a resulting value of the sub-objective function h(λ) may decrease (such as decrease in value) as a fairness increases, a capacity, r, increases, or both. Additionally, or alternatively, h(λ) may vary for each AP 102 included within the mesh network, which may be denoted by the index i In such examples, the sub-objective function may further be associated with a normalization function given by Equation 2, shown below.

$$\hat{h} ( λ ) = max ( 0 , 1 + \frac{f ( d )}{B} ) ∼ ( 0 , 1 ) \qquad ( 2 )$$

Additionally, or alternatively, in some other examples, the sub-objective function may be a latency SLA sub-objective function, such as the sub-objective function given by Equation 3, shown below.

$$f ( d ) = 1 - {e}^{d / D} \qquad ( 3 )$$

In such examples, the latency SLA sub-objective function ƒ(d) may be a function of delay d (such as a latency, such as end-to-end latency). In such examples, a resulting value of the latency SLA sub-objective function ƒ(d) may decrease (such as decrease in value) as the delay increases (such as compared to a delay D specified by the latency SLA). In some implementations, the latency SLA sub-objective may further be associated with a normalization function given by Equation 4, shown below.

$$\hat{f} ( d ) = E [ max ( 0 , 1 + \frac{f ( d )}{B} ) ] ∼ ( 0 , 1 ) \qquad ( 4 )$$

Additionally, or alternatively, the sub-objective function may be a throughput SLA sub-objective function such as the sub-objective function given by Equation 5, shown below.

$$g ( λ ) = ln ( λ / Λ ) \qquad ( 5 )$$

In such examples, a value of the throughput SLA sub-objective function g(λ) may decrease (such as decrease in value) as a throughput λ increases (such as compared to the throughput Λ specified by the throughput SLA). In some implementations, the throughput SLA sub-objective may further be associated with a normalization function given by Equation 6, shown below.

$$\hat{g} ( λ ) = E [ \frac{min ( max ( LB , g ( λ ) ) , UB ) - LB}{U B - L B} ] ∼ ( 0 , 1 ) \qquad ( 6 )$$

In some implementations, the objective function may include multiple weighted sub-objective functions. For example, the AP 102 may weigh (such as increase or decrease the value of) each sub-objective function of the multiple sub-objective functions (such as based on a respective performance impact of each sub-objective function). For example, the AP 102 may define the objective function to include a sum of multiple weighted sub-objective functions given by Equation 7, shown below.

$$obj = {w}_{f} \hat{f} ( {d}_{i = 1 , 2 , …} ) + {w}_{g} \hat{g} ( {λ}_{i = 1 , 2 , …} ) + {w}_{h} \hat{h} ( {λ}_{i = 1 , 2 , …} ) \qquad ( 7 )$$

In such examples, \hat{ƒ}(d_{i=1, 2, . . .} ), ĝ(λ_{i=1, 2, . . .} ), and ĥ(λ_{i=1, 2, . . .} ) may be examples of the latency SLA sub-objective, the throughput SLA sub-objective, and the fairness and capacity sub-objective, respectively, which may each be associated with the respective weights w_{ƒ}, w_{g}, and wₕ.

Additionally, or alternatively, the AP 102 may define the objective function to be one or more conditional forms including the \hat{ƒ}(d_{i=1, 2, . . .} ), ĝ(λ_{i=1, 2, . . .} ), ĥ(λ_{i=1, 2, . . .} ); or any combination thereof based on one or more performance factors (such as performance indicators). For example, the AP 102 may give precedence to certain performance factors by defining the objective function to be one of \hat{ƒ}(d_{i=1, 2, . . .} ), ĝ(λ_{i=1, 2, . . .} ), or ĥ(λ_{i=1, 2, . . .} ). For example, the precedence of performance factors may be given by Equation 8, shown below.

$$obj = \{ \begin{matrix}\hat{f} ( {d}_{i = 1 , 2 , …} ) & if ∀ \frac{{d}_{i}}{{D}_{i}} > θ \\ \hat{g} ( {λ}_{i = 1 , 2 , …} ) & if ∀ \frac{{Λ}_{i}}{{λ}_{i}} > θ and all \frac{{d}_{i}}{{D}_{i}} < θ \\ \hat{h} ( {λ}_{i = 1 , 2 , …} ) & o . w .\end{matrix} \qquad ( 8 )$$

Particular aspects of the subject matter described herein with respect to FIG. 3 can be implemented to realize one or more of the following potential benefits. For example, by receiving the set of operating parameters 310 from the DNN 302 based on inputting the set of mesh scenario parameters 304 and based on the supervised learning 306, the reinforcement learning 308, or both, the AP 102 may efficiently identify many (such as hundreds or more) of operating conditions associated with the AP 102, the mesh, or both. That is, based on training the ML model with the set of mesh scenario parameters 304 corresponding to multiple (such as hundreds or thousands) mesh network scenarios including configurations and performance metrics of one or more different APs of the mesh network, the DNN 302 may generate, and the AP 102 may receive, a set of operating parameters 310 based on a current set of mesh scenario parameters 304 that may improve overall mesh network performance (such as the performance of the AP 102 and the performance of the one or more different APs of the mesh network simultaneously). Additionally, or alternatively, performing communications according to the set of updated local operating parameters (such as the output of the ML model) may enable the AP to perform wireless communications that satisfy (such as benefit) a current mesh network scenario, satisfy multiple performance requirements, multiple SLAs, or any combination thereof (such as without performance tradeoffs between the requirements or SLAs). For example, the ML model may generate and output, and the AP may receive, a set of updated local operating parameters that satisfy a latency SLA, a throughput SLA, and a fairness requirement simultaneously.

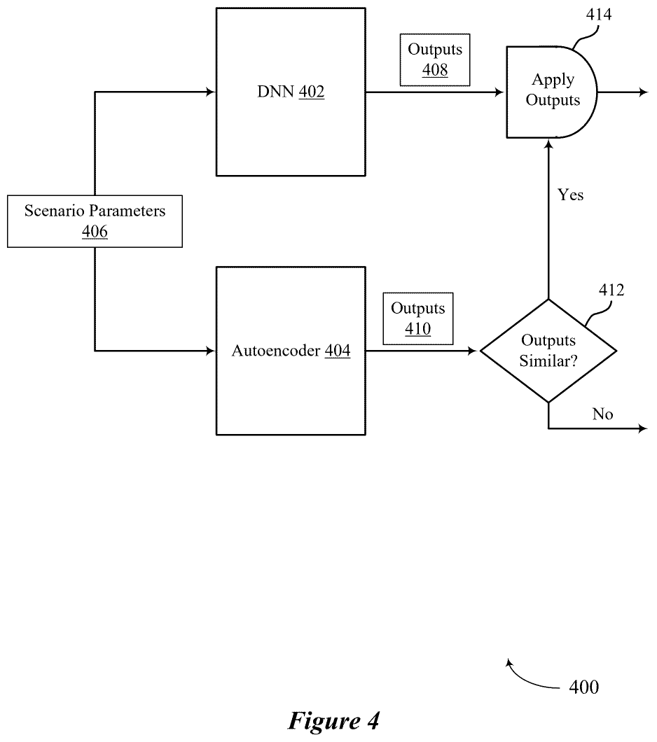

FIG. 4 shows an example of a flow diagram 400 that supports artificial intelligence-based Wi-Fi mesh configuration. In accordance with the block diagram 400, the AP 102 may utilize (such as implement) a DNN 402 and an autoencoder 404 to select a set of updated operating parameters. In such examples, the AP 102 (such as via the DNN 402) may utilize one or more supervised learning models to receive and select the set of updated operating parameters.

In some implementations, via supervised learning, the AP 102 may train the DNN 402 to predict (such as generate, or identify, among other examples) the set of updated operating parameters. For example, the DNN 402 may predict a relatively well-performing set of operating parameters (such as a best-performing configurations out of multiple sets of configurations evaluated) for each operating scenario of the AP 102. In some examples, the AP 102 may train the DNN 402 via offline training, and may access the updated set of operating parameters (such as a set of operating parameters for a given scenario) at a subsequent time. In some implementations, the AP 102 may input a set of parameters (such as hundreds or more parameters, or features) representing a current scenario into the DNN 402. In such implementations, the DNN 402 may correspondingly output the set of updated operating parameters (such as hundreds or more outputs representing a configuration of at least the AP 102).

In some implementations, the AP 102 may train the DNN 402 according to one or more initial operating parameters (such as starting points for the training). In such implementations, the AP 102 may select one or more operating parameters as the initial parameters. For example, the AP 102 may select a link (such as a preferred link) with a high bandwidth as an initial parameter. In such examples, the DNN 402 may determine to maintain the link (such as a preferred link) based on the link performing well (such as compared to one or more other configurations of the AP 102) during a current scenario of the AP 102. Additionally, or alternatively, the DNN 402 may determine to select a different link from the link (such as the preferred link) based on the initially selected link (such as the high bandwidth link) performing relatively less well than the different link during the current scenario of the AP 102.

Additionally, or alternatively, the DNN 402 may generate outputs 408 according to a set of rules (such as heuristics for complexity reduction). For example, if a link has a relatively high delay (such as a high end-to-end latency compared to one or more different links, or a latency SLA) the DNN 402 may assign a higher scheduling probability to (such as probability of scheduling traffic on) one or more non-preferred links. Additionally, or alternatively, the DNN 402 may avoid (such as reject configurations including) one or more negative scenarios. For example, the DNN 402 may avoid scenarios including non-preferred links with low scheduling probability when the link (such as the preferred link) has the high delay.

In some implementations, the AP 102 may utilize the autoencoder 404 to verify (such as check a validity, or check an accuracy, among other examples) of the outputs 408 of the DNN 402 (such as the sets of updated operating parameters). In such implementations, the autoencoder 404 may detect additional scenarios (such as scenarios of the AP 102) that are significantly different (such as scenarios where most parameters of the set of operating parameters are different) from one or more previously trained samples (such as sets of updated operating parameters trained during offline learning). In some examples, the AP 102 may input a set of scenario parameters 406 (such as hundreds or more parameters, or features) representing a additional scenario into the autoencoder 404. In such examples, the outputs 410 of the autoencoder 404 may indicate a similarity between a set of updated operating parameters (such as the outputs 408) associated with the additional scenario, and one or more previously trained sets of updated operating parameters.

In some examples, at 412, the AP 102 may determine whether the outputs 410 are similar (such as within a threshold difference) from the outputs 408. In some examples, the outputs 410 may be similar to the outputs 408 (such as a total difference, or individual differences for respective parameter values, between the outputs 408 and the outputs 410 may be within a threshold offset). In such examples, at 414, the AP 102 may apply the outputs 408 (such as apply the outputs 408 to perform wireless communications of the AP 102). In some other examples, such as when the outputs 410 and the outputs 408 are not similar (such as based on the comparison of 412), the AP 102 may trigger additional searching (such as trigger the AP 102 to train the DNN 402) for one or more additional configurations (such as one or more additional outputs of the DNN 402 that represent a well-performing configuration for the scenario of the AP 102).

In some implementations, the DNN 402 may include at least two layers (such as hidden layers), and each layer may include multiple nodes (such as hundreds or more neurons). In some examples, the DNN 402 may perform many (such as millions or more) multiply-and-accumulate operations within a threshold amount of time (such as 10 milliseconds, for an example). In some examples, the autoencoder 404 may perform many (such as millions or more) multiply-and-accumulate operations within a threshold amount of time (such as 10 milliseconds, for an example). Additionally, or alternatively, the DNN 402, the autoencoder 404, or both may perform the multiply-and-accumulate operations according to a periodicity (such as one set of multiply-and-accumulate operations at each 10 second interval). In some implementations, the DNN 402 may utilize one or more search algorithms to determine (such as identify, or generate, among other examples) the set of updated operating parameters. For example, the DNN 402 may be a genetic algorithm, a partial swarm algorithm, a covariance matrix adaptation evolution algorithm, a stochastic policy gradient algorithm, or other search algorithms.

Particular aspects of the subject matter described herein with respect to FIG. 4 can be implemented to realize one or more of the following potential benefits. In some examples, utilizing the autoencoder 404 (such as for situations utilizing supervised learning, among other examples) the AP 102 may efficiently identify sets of updated local operating parameters. For example, by comparing an output of the autoencoder 404 to an output of the DNN 402, the AP 102 may efficiently determine whether the output of the DNN 402 (such as the set of updated local operating parameters) is applicable to a current scenario of the AP 102, or whether to perform additional searching.

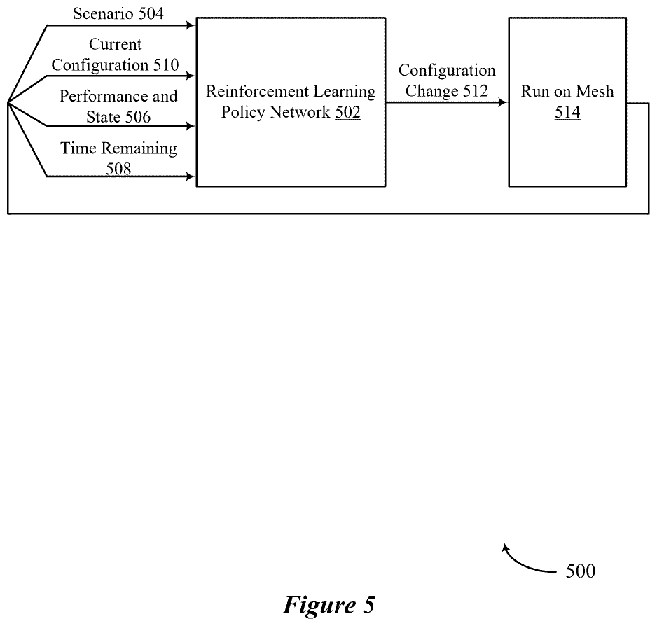

FIG. 5 shows an example of a flow diagram 500 that supports artificial intelligence-based Wi-Fi mesh configuration. In accordance with the block diagram 500, the AP 102 may utilize (such as implement) a reinforcement learning policy network 502 to determine (such as generate, identify, or select, among other examples) a set of updated operating parameters for the AP 102. In such examples, the AP 102 may utilize one or more reinforcement learning models (such as may perform reinforced learning to improve an ML model) to receive and select the set of updated operating parameters. In some examples, the AP 102 may implement the reinforcement learning policy network 502 via a stochastic policy gradient algorithm, among other examples of search algorithms.

In some implementations, the AP 102 may search for (such as learn to search for) the set of updated operating parameters using the reinforcement learning policy network 502. In some examples, the AP 102 may implement the reinforcement learning policy network 502 to search for additional configurations (such as one or more sets of updated operating parameters) for additional scenarios of the AP 102. In some examples, the AP 102 may define an episode (such as learning episode, or training episode). In such examples, the episode may include a series of configuration adjustments within a defined duration of time. For example, the episode may be defined to be a series of configuration adjustments within a few seconds (such as three seconds, for an example).

In some implementations, the AP 102 may define one or more states (such as operation states of the AP 102, the mesh, or both). In such examples, the one or more states may include a scenario 504 (such as operational parameters or measured environmental parameters of a scenario of the AP 102, such as a traffic pattern of the AP 102), a current performance 506 associated with the state (such as a performance associated with one or more performance metrics), a time remaining 508 (such as a duration of time remaining within the episode, or a convergence time), and a current configuration 510 (such as a current configuration at, such as current operational parameters being utilized by, the AP 102). Additionally, or alternatively, the AP 102 may define one or more actions including one or more configuration changes 512 (such as changes to the configuration of the AP 102). For example, the one or more configuration changes 512 may include a change to a scheduling probability of a MLO link.

In some implementations, the AP 102 may define (such as identify, determine, or generate, among other examples) one or more reward functions for the reinforcement learning policy network 502. In some examples, the reward function may be based on a weighted performance improvement. In such examples, the AP 102 may determine (such as calculate) a value of the weighted performance improvement based on a duration of time remaining within the episode (such as an amount of time remaining to perform a configuration change). For example, a reward based on a state determined at the beginning of an episode (such as with most of the episode duration remaining) may receive a greater weight than a reward based on a state determined at the end of an episode. Additionally, or alternatively, the weighted performance improvement may further be based on a relative magnitude of a performance impact associated with the state.

In some implementations, the episode may include a procedure (such as a procedure with multiple iterations) for identifying (such as learning) a set of well-performing operating parameters. In some examples, the AP 102 may identify an initial state (such as an initial configuration for an initial scenario) for the AP 102, and the AP 102 may input the scenario (such as including the scenario 504, the current performance 506, the time remaining 508, and the current configuration 510) into the reinforcement learning policy network 502 (such as a forward pass through the reinforcement learning policy network 502). In such examples, the AP 102 may receive, from the reinforcement learning policy network 502, an initial configuration for the AP 102 (such as a set of initial operating parameters). The AP 102 may use the additional configuration to run the mesh 514 for a fixed time (such as for one second, among other examples). In such examples, the AP 102 may determine (such as generate or calculate, among other examples) a reward function according to the techniques described herein. For example, the AP 102 may determine the reward function based on one or more performance metrics associated with the network based on applying the set of initial operating parameters. Additionally, or alternatively, the AP 102 may update the initial state to reflect (such as update the initial state with the contents of) the received set of initial parameters. In such examples, the AP 102 may input the updated state and the reward function into the reinforcement learning policy network 502. Additionally, or alternatively, the AP 102 may repeatedly generate sets of updated parameters for the remainder of the episode time. Accordingly, in such examples, the AP 102 and the reinforcement learning policy network 502 may converge (such as, the configuration may stabilize) to a well-performing set of operating parameters (such as a best-performing set of operating parameters out of multiple sets of operating parameters applied during the episode).

In some implementations, the AP 102 may train the reinforcement learning policy network 502 by collecting (such as sampling and storing) a dataset of multiple sets of states, actions, and rewards from multiple episodes (such as diversification of a training set of samples). In some examples, each set may be based on a different respective initial state of the AP 102. In such examples, the AP 102 may update the reinforcement learning policy network 502 with each set (such as each batch of collected episode data) of the dataset.

Particular aspects of the subject matter described herein with respect to FIG. 5 can be implemented to realize one or more of the following potential benefits. In some implementations, determining the set of updated local operating parameters according to a reinforcement learning procedure may enable the AP 102 to efficiently and effectively determine a set of updated local operating parameters that benefit communications at the AP 102. For example, utilizing a reward function may enable the AP 102 (such as via the reinforcement learning policy network 502) to efficiently search for a set of updated local operating parameters based on the performance of the AP 102. In such example, the AP 102 (such as via the reinforcement learning policy network 502) may infer a next set of updated local operating parameters based on one or more previously generated sets of local operating parameters (such as without performing unnecessary searching) based on the previous set of operating parameters and the reward function.

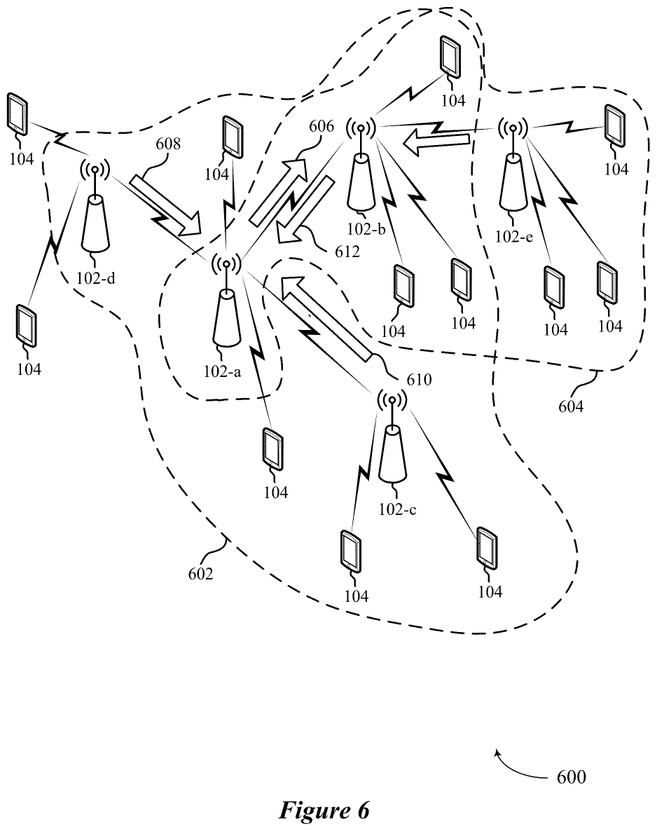

FIG. 6 shows an example of a signaling diagram 600 that supports artificial intelligence-based Wi-Fi mesh configuration. In accordance with the signaling diagram 600, an immediate hop 602 may be a portion of a mesh network including an AP 102-a, which may be associated with (such as perform communications with) an AP 102-b, an AP 102-c, and an AP 102-d. Additionally, or alternatively, each of the AP 102-a, the AP 102-b, the AP 102-c, and the AP 102-d may perform communications with one or more STAs 104. Additionally, or alternatively, an immediate hop 604 may include the AP 102-b, which may be associated with (such as perform communications with) the AP 102-a and an AP 102-e. Additionally, or alternatively, each of the AP 102-a, the AP 102-b, and the AP 102-e may perform communications with one or more STAs 104. The AP 102-a, the AP 102-b, the AP 102-c, the AP 102-d and the AP 102-e may each be examples of the AP 102. Although the procedures described herein with respect to FIG. 6 are illustrated as being implemented by the AP 102-a, the AP 102-b, the AP 102-c, the AP 102-d, the AP 102-e, or other wireless communication devices may implement the procedures without exceeding the scope of this present disclosure.

In some examples, utilizing an ML model at a centralized location (such as an AP 102, a cloud server, or a controller device, among other examples) may be inefficient and may be difficult to adapt to different mesh scenarios (such as arbitrary mesh scenarios). For example, including (such as, in an ML model or in selection of operational parameters) a set of operating parameters (such as feature sets) for multiple devices in a mesh network at a centralized location may include many (such as hundreds or thousands) of parameters, which may not scale to accommodate a mesh network with many devices (such as more than one or two APs 102). Additionally, or alternatively, obtaining training samples (such as, for the ML model) from various deployment scenarios (such as mesh network scenarios) may be impractical at a centralized location. For example, a single AP 102 may be unable to determine a scenario for a broader mesh network, or to account for individual operations and configurations at each node in the mesh network.

Techniques described herein with reference to FIG. 6 may enable ML model-based operating parameters to scale to a 2-hop mesh network. In some implementations, each AP 102 of the mesh network (such as such as each AP 102 of the immediate hop 602 and the immediate hop 604) may deploy an ML model to locally determine one or more sets of operating parameters.

In some implementations, each AP 102 may input a set of inputs (such as encoded mesh network scenarios) into each local ML model at the APs 102. In some examples, each set of inputs may include one or more features (such as feature scheme) for a current hop (such as one or more operation parameters for the immediate hop 602 at the AP 102-a), one or more features of a next hop (such as one or more operation parameters for the immediate hop 602 at the AP 102-a), or any combination thereof. In some examples, the one or more features for the immediate hop may include traffic information for each traffic flow of the associated STAs 104 (such as the STAs 104 associated with each AP 102), a pathloss per associated STA 104, an interference basic service set (BSS) per BSS, channel information per BSS, or any combination thereof. Additionally, or alternatively, the one or more features for the next hop may include traffic information for each traffic flow of one or more associated backhaul STAs 104, a pathloss per associated backhaul STA 104, an interference BSS per BSS, channel information per BSS, or any combination thereof. Thus, each AP 102 may utilize an ML model according to a limited quantity of hops (such as two hops), where each AP 102 may benefit from inputting parameters corresponding to local deployments for itself, an upstream AP 102, a downstream AP 102, or any combination thereof (such as utilizing the ML model in accordance with an impact of various configurations on other APs 102, but without relying on such information across an entire mesh network).

In some implementations, the AP 102-a may exchange (such as communicate) a message 606 with at least the AP 102-b (such as at least one downstream agent). In some examples, the AP 102-a may configure (such as apply a set of operating parameters for) an immediate hop associated with the AP 102-a (such as including the associated STAs 104). Additionally, or alternatively, the AP 102-a may exchange (such as communicate) a message 608 with at least the AP 102-d (such as at least one upstream agent). In such examples, the AP 102-a may receive the message 608 from the AP 102-d. The AP 102-a may additionally receive a message 610 and a message 612 (such as including similar contents as the message 608) from the AP 102-c and the AP 102-b, respectively.

In some examples, the message 606 may include an indication of a set of local operating parameters of the AP 102-a (such as operating parameters associated with the immediate hop of the AP 102-a). Additionally, or alternatively, the message 606 may include an indication of a traffic pattern at the AP 102-a. Additionally, or alternatively, the message 608 may include an indication of a set of operating parameters of the AP 102-d (such as a set of upstream operating parameters), and indication of a traffic pattern of the AP 102-d, or both.

In some implementations, the AP 102-a may input the set of local operating parameters (such as the operating parameters associated with the immediate hop of the AP 102-a), the set of upstream operating parameters (such as the set of operating parameters associated with the AP 102-d and received via the message 608), or both into an ML model deployed at the AP 102-a. In some examples, the ML model may output a set of updated local operating parameters, and the AP 102-a may configure the immediate hop of the AP 102-a with the set of updated local operating parameters. In some examples, configuring the immediate hop of the AP 102-a may impact (such as improve or degrade) a traffic pattern of one or more downstream agents of the AP 102-a (such as the AP 102-b). The AP 102-a may additionally include an indication of the set of updated local operating parameters in the message 606.

Additionally, or alternatively, the AP 102-a may (such as during reinforcement learning) determine (such as generate, calculate, or identify, among other examples) a reward function for the ML model. In some examples, the reward function may be based on the traffic pattern of the AP 102-d (such as indicated by the message 608). In such implementations, the traffic pattern of the AP 102-d may be based on a configuration of the AP 102-a. Additionally, or alternatively, the AP 102-a may determine the reward function based on the traffic pattern, one or more performance metrics associated with the AP 102-d, or both. For example, the reward function for the ML model at the AP 102-a may be based on one or more traffic patterns of one or more upstream agents, and the performance of the one or more upstream agents may be based on a configuration of the AP 102-a.

Particular aspects of the subject matter described herein with respect to FIG. 6 can be implemented to realize one or more of the following potential benefits. In some examples, enabling the APs 102 (such as the AP 102-a, among other APs 102) to communicate one or more reports with each one-hop upstream agent and each one-hop downstream agents may enable each AP 102 in a mesh network to adjust (such as generate) a respective set of updated local operating parameters for each AP 102 based on an overall (such as distributed) performance of the mesh network. For example, each AP 102 may generate a set of updated local operating parameters based on the performance and configuration of each upstream agent and each downstream agent communicating with the AP 102, which may be distributed across the mesh network.

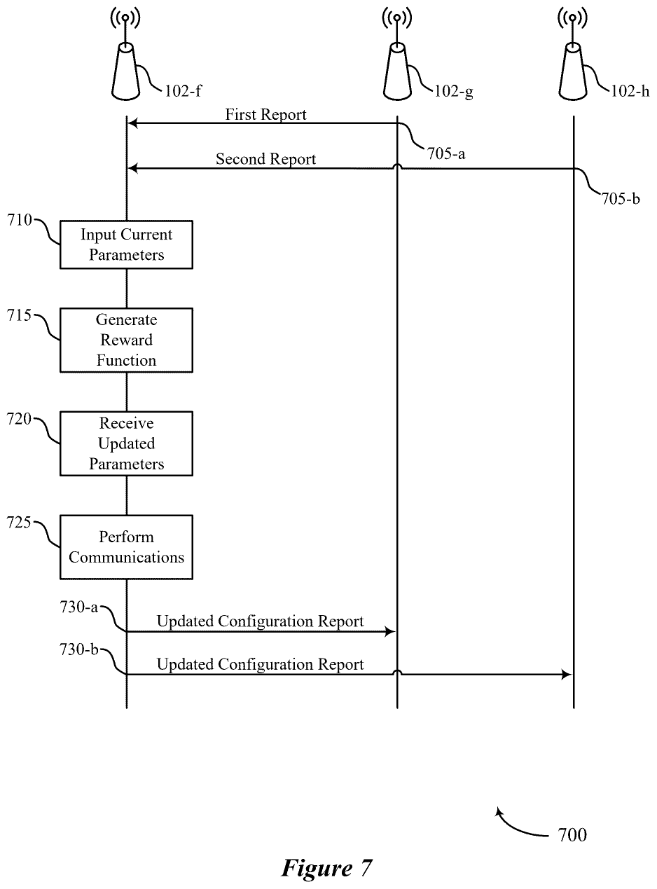

FIG. 7 shows an example of a process flow 700 that supports artificial intelligence-based Wi-Fi mesh configuration. The process flow 700 may be implemented by an AP 102-f, an AP 102-g, and an AP 102-h, which may each be an example of the AP 102. Although the process flow 700 is illustrated as including three APs 102, the process flow 700 may include any quantity of APs 102 without exceeding the scope of the present disclosure.

In some cases, for configuring a standalone AP 102 (such as for smart configuration), the state (such as scenario) of the standalone AP 102 has relatively few dimensions (such as compared to multiple connected APs 102, among other devices in a network). In such cases, determining the set of configurations may be based on a set of operating parameters (such as heuristics). In some other cases, a mesh network state (such as scenario) is high dimensional (such as having many configurations compared to the standalone AP 102). In such cases, determining a set of operating parameters (such as heuristics) for the mesh network state may be complex (such as compared to the standalone AP 102).

In some cases, a mesh backhaul network may adjust (such as balance) a mesh backhaul load to increase end-to-end throughput. Additionally, or alternatively, in some cases, a serving AP MLD may adjust (such as balance) an AA to relieve AA bottleneck, adjust (such as balance) a traffic load to meet a latency SLA, adjust (such as balance) a traffic load to meet throughput SLA, or any combination thereof.

In some examples, a mesh network may configure (such as via one or more APs 102 of the mesh network) the probability of scheduling multiple MAC service data units (MSDUs) of a traffic flow on an MLO link with a probability

$${q}_{l i n k}^{flow}$$

between 0 and 1 (such as distributing a traffic load across MLO links defined by

$${p}_{l i n k}^{flow} )$$

to satisfy an overall performance objective (such as a performance objective for the mesh network). In such cases, one or more performance objectives may include a latency SLA for a flow a (such as dₐ<Dₐ), a throughput SLA for a flow c (such as λ_{c}>Λ_{c}), a tradeoff between fairness and aggregate throughput among a flow b and a flow c (such as max (log λ_{b}+log λ_{c})), or any combination thereof.

Techniques described herein may enable an adaptive system to configure many (such as hundreds or more) of mesh operational parameters to relatively improve the network performance. In some implementations, an AP 102 may configure a link (such as a preferred link) and a scheduling probability for a MLO link for each mesh AP 102 of a mesh network to satisfy an end-to-end latency SLA, an end-to-end throughput SLA, an end-to-end fairness, an aggregate end-to-end throughput, or any combination thereof.

At 705-a, the AP 102-f may obtain a first report from the AP 102-g (such as a downstream AP). In some examples, the first report may include an indication of set of operating parameters associated with the AP 102-g. At 705-b, the AP 102-f may further obtain a second report from the AP 102-h (such as an upstream AP) including an indication of a set of operating parameters associated with the AP 102-h, an indication of a traffic pattern of the AP 102-h, or both.

In some implementations, the set of operating parameters associated with the AP 102-g, the set of operating parameters associated with the AP 102-h, a set of local operating parameters associated with the AP 102-f, or any combination thereof may include one or more aspects (such as within a feature set) of a mesh network scenario (such as one or more mesh network scenarios including at least each AP 102 of the AP 102-f, the AP 102-g, or the AP 102-h, respectively). For example, each feature set may include an indication of a network topology (such as a connection topology of a mesh network), an indication of an AP-to-STA association structure, a channel map and an indication of one or more channel conditions associated with the channel map, an indication of a traffic flow distribution over the network topology, an indication of a traffic demand, one or more SLAs of each traffic flow, or any combination thereof.

In some implementations, each feature set may be encoded according to one or more information schemas (such as feature schemas). In some examples, each feature set may be encoded (such as by the AP 102-f, among other examples), according to a first example of a schema (such as feature schema A). In such examples, each aspect of the mesh network (such as each aspect included in each feature set) may be encoded within the feature set separately (such as without a link between one or more features being included within the feature set). Additionally, or alternatively, each aspect (such as, each input value) may be associated with an identifier (ID) (such as a flow ID, a STA ID, an AP ID, among other examples) included as a feature in the feature set. For example, a feature set may include one or more parameter values corresponding to the AP 102-f, the AP 102-g, the AP 102-h, or any combination thereof, which may be associated with one or more AP IDs, respectively. In such examples, an association (such as connection, or link, among other examples) may be determined between two or more features based on IDs associated with the features. For instance, a flow ID, a STA ID, an AP ID, or the like, may be included as features to represent their respective linkages.

In some implementations, encoding a feature set according to the first example of an encoding schema (which may be referred to as feature schema A) may include grouping the features of the feature set according to one or more categories (such as information types). For example, a topology grouping may include a one-hop backhaul STA association for each backhaul BSS of the mesh network, a two-hop backhaul STA association for each backhaul BSS, a fronthaul client association encoding for each fronthaul BSS, a pathloss for each device association of the mesh network, an interference BSS per BSS, or any combination thereof. Additionally, or alternatively, a traffic grouping may include a traffic demand per traffic flow, a traffic direction per traffic flow, a SLA per traffic flow, a flow association per client (such as per client device associated with the mesh network) or any combination thereof, and a channel grouping may include one or more channel numbers per AP MLD, a channel bandwidth for each BSS, a channel access delay for each BSS, an out-of-network overlapping BSS (OBSS) airtime use for each BSS, or any combination thereof. In some implementations, each feature set may include at least the topology grouping, the traffic grouping, the channel grouping, or any combination thereof. In some examples, each feature may correspond to a respective ID (such as, a flow ID, a STA ID, or an AP ID).

Additionally, or alternatively, each feature set may be encoded according to a second example of an encoding schema (which may be referred to as feature schema B). In such examples, a mesh network scenario may be encoded (such as by the AP 102-f, among other examples) hierarchically according to a topology (such as a tree topology) of the mesh network. In such examples, feature input positions (such as, for the inputs to the ML model) may indicate (such as directly reflect) the traffic layout over the topology of the mesh network. For example, a positioning (such as an ordering, or ranking, among other examples) of the features of a feature set may represent (such as outline) a network tree (such as device tree, or traffic flow tree, among other examples). In such examples, the network tree may indicate the mesh network topology and the relative position (such as device association) of traffic flows within the mesh network.

In some implementations, encoding a feature set according to the second example of an encoding scheme (such as feature schema B) may include grouping each feature of each feature set according to a relative position (such as association) within the mesh network topology. For example, a root AP grouping (such as a grouping of features associated with the AP 102-f) may include traffic information for each flow for each backhaul STA associated with the root AP, a pathloss per backhaul STA associated with the root AP, an interference BSS per BSS associated with the root AP, channel information per BSS associated with the root AP, or any combination thereof. Additionally, or alternatively, a one-hop repeater grouping (such as a grouping of features associated with the AP 102-g or the AP 102-h) may include traffic information for each flow for each backhaul STA associated with the one-hop repeater, a pathloss per backhaul STA associated with the one-hop repeater, an interference BSS per BSS associated with the one-hop repeater, channel information per BSS associated with the one-hop repeater, or any combination thereof, and an N-hop repeater grouping (such as a grouping of features associated with a hop N hops away) may include traffic information for each flow for each backhaul client associated with the N-hop repeater, a pathloss per backhaul client associated with the N-hop repeater, an interference BSS per BSS associated with the N-hop repeater, channel information per BSS associated with the N-hop repeater, or any combination thereof. In such examples, traffic and channel information are organized in the ML inputs (such as ANN inputs) to directly reflect their connections to the topology.

At 710, the AP 102-f may input the set of operating parameters associated with the AP 102-g, the set of operating parameters associated with the AP 102-h, the set of local operating parameters associated with the AP 102-f, or any combination thereof into an ML model (such as an ML model operated at the AP 102-f). In some examples, the AP 102-f and the ML model may utilize supervised learning, further described herein with reference to FIG. 4. Additionally, or alternatively, the AP 102-f and the ML model may utilize reinforcement learning, further described herein with reference to FIG. 5. In some examples, inputting the set of operating parameters associated with the AP 102-g, the set of operating parameters associated with the AP 102-h, the set of local operating parameters associated with the AP 102-f may be in accordance with the feature schema A, the feature schema B, or both.

At 715, the AP 102-f may, in accordance with performing reinforcement learning, and as described further herein with reference to FIG. 5, generate a reward function for the ML mode. In some examples, the AP 102-f may generate (such as calculate, identify, or select, among other examples) the reward function based on one or more performance metrics associated with the AP 102-f, an amount of time remaining within a learning episode of the ML model, or both. In some examples, the AP 102-f may additionally generate the reward function based on the traffic pattern of the AP 102-h. In some examples, a configuration of the AP 102-f may impact the traffic pattern of at least the AP 102-h. In such examples, the traffic pattern of the AP 102-h may indicate (such as reflect) an overall performance of the mesh network in accordance with the configuration of the AP 102-f.

At 720, the AP 102-f may receive (such as the ML model may generate) a set of outputs of the ML model including a set of updated local operating parameters of the AP 102-f. In some examples, the set of outputs may include multiple indications (such as hundreds or more) of a MLO link (such as a preferred MLO link) for each MLD associated with the mesh network, multiple indications (such as hundreds or more) of a latency threshold when using non-preferred MLO links for each MLD, multiple indications (such as hundreds or more) of a probability of queuing schedule commands of a flow per MLO link, or any combination thereof. In some implementations, generating the set of updated local operating parameters may be in accordance with supervised learning, reinforcement learning, or both. In some examples, generating the set of outputs of the ML model in accordance with reinforcement learning may further be based on generating (such as and inputting into the ML model) the reward function.

At 725, the AP 102-f may perform communications with one or more entities (such as devices, or agents, among other examples) associated with the mesh network in accordance with the set of updated local operating parameters. For example, the AP 102-f may communicate with one or more STAs 104 associated with a hop of the AP 102-f (such as among other clients associated with the hop). In some examples, the AP 102-f may additionally communicate with one or more APs 102, including the AP 102-g and the AP 102-f. In some implementations, performing communications with the one or more entities may

Additionally, or alternatively, the AP 102-f may determine (such as measure, or calculate, among other examples) a performance associated with the communications of the AP 102-f based on the set of updated local operating parameters. For example, the AP 102-f may measure one or more performance metrics associated with the communications. Additionally, or alternatively, the AP 102-f may determine a traffic pattern of the AP 102-f. In some examples, the traffic pattern of the AP 102-f may be based on the set of updated local operating parameters, a configuration of the AP 102-g, a configuration of the AP 102-h, or any combination thereof.

At 730-a, the AP 102-f may output a report (such as an updated configuration report) to the AP 102-g. In some examples, the report may include an indication of the set of updated local operating parameters, an indication of the performance of the AP 102-f based on the set of updated local operating parameters (such as an indication of the one or more performance metrics), an indication of the traffic pattern of the AP 102-f, or any combination thereof. In some examples, the AP 102-g may update a configuration (such as generate, via an ML model, an additional configuration) of the AP 102-g based on the updated configuration report.

At 730-b, the AP 102-f may output a report (such as an updated configuration report) to the AP 102-h. In some examples, the report may include an indication of the set of updated local operating parameters, an indication of the performance of the AP 102-f based on the set of updated local operating parameters (such as an indication of the one or more performance metrics), or both. In some examples, the AP 102-h may update a configuration (such as generate, via an ML model, an additional configuration) of the AP 102-h based on the updated configuration report. In some examples, obtaining the first report, obtaining the second report, outputting the updated configuration report, or any combination thereof, may be in accordance with techniques described herein with reference to FIG. 6.

Particular aspects of the subject matter described herein with respect to FIG. 7 can be implemented to realize one or more of the following potential benefits. In some examples, by receiving the set of updated local operating parameters from the ML model based on inputting a previous set of operating parameters, the set of operating parameters associated with the AP 102-g, the set of operating parameters associated with the AP 102-h or any combination thereof via one or more of the techniques described herein, the AP 102-f may efficiently identify many (such as hundreds or more) operating parameters associated with the AP 102-f, the mesh network, or both. Additionally, or alternatively, performing communications according to the set of updated local operating parameters (such as the output of the ML model) may enable the AP 102-f to perform wireless communications that satisfy multiple performance requirements, multiple SLAs, or any combination thereof (such as while mitigating performance tradeoffs between the requirements or SLAs). For example, the ML model may generate and output, and the AP 102-f may receive, a set of updated local operating parameters that satisfy a latency SLA, a throughput SLA, and a fairness requirement simultaneously.

In some examples, by outputting updated configuration report indicating the set of updated local operating parameters, the one or more performance metrics, or both to the AP 102-g the AP 102-h, or both, the AP 102-f may indicate to the AP 102-g, the AP 102-h, or both (such as one or more different upstream APs, downstream APs, or both), the set of updated local operating parameters utilized by the AP 102-f, as well as an indication of whether the set of updated local operating parameters are beneficial to communications at the AP 102-f (such as relatively improve the performance of the AP 102-f with regard to the one or more performance metrics, one or more SLAs, or both). In such examples, multiple APs of the mesh network may coordinate (such as identify or determine) multiple sets of operating parameters for each AP of the mesh network (such as to relatively improve the overall performance of the mesh).

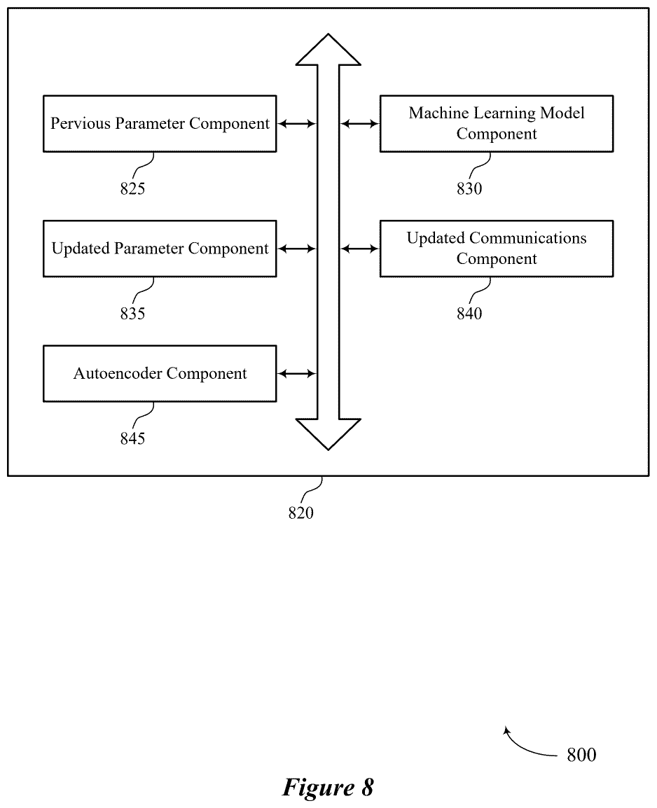

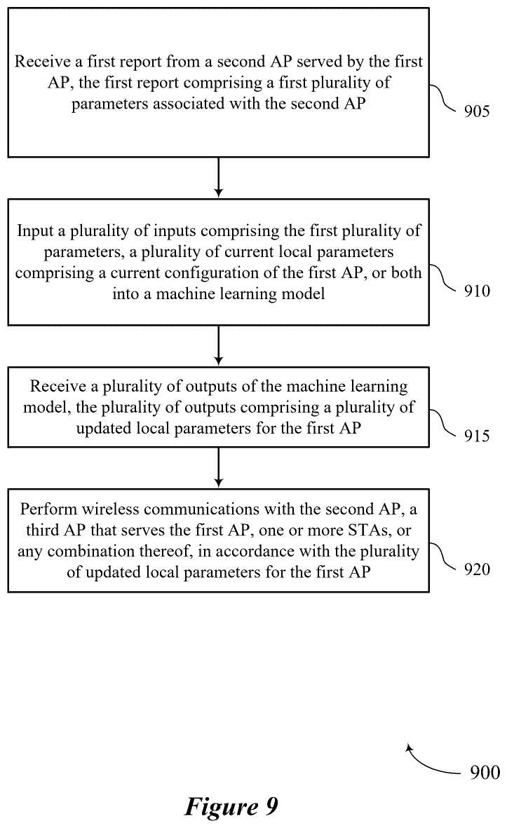

FIG. 8 shows a block diagram of an example wireless communication device 800 that supports artificial intelligence-based Wi-Fi mesh configuration. In some examples, the wireless communication device 820 is configured to perform the processes 900, 1000, 1100, 1200, and 1300 described with reference to FIGS. 9, 10, 11, 12, and 13, respectively. The wireless communication device 820 may include one or more chips, SoCs, chipsets, packages, components or devices that individually or collectively constitute or include a processing system. The processing system may interface with other components of the wireless communication device 820, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 820 may transmit the information output from the chip. In such an example, the second interface may refer to an interface between the processing system of the chip and a reception component, such that the wireless communication device 820 may receive information that is then passed to the processing system. In some such examples, the first interface also may obtain information, such as from the transmission component, and the second interface also may output information, such as to the reception component.

The processing system of the wireless communication device 820 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 820 can be configurable or configured for use in an AP, such as the AP 102 described with reference to FIG. 1. In some other examples, the wireless communication device 820 can be an AP that includes such a processing system and other components including multiple antennas. The wireless communication device 820 is capable of transmitting and receiving wireless communications in the form of, for example, wireless packets. For example, the wireless communication device 820 can be configurable or configured to transmit and receive packets in the form of physical layer PPDUs and MPDUs conforming to one or more of the IEEE 802.11 family of wireless communication protocol standards. In some other examples, the wireless communication device 820 can be configurable or configured to transmit and receive signals and communications conforming to one or more 3GPP specifications including those for 5G NR or 6G. In some examples, the wireless communication device 820 also includes or can be coupled with one or more application processors which may be further coupled with one or more other memories. In some examples, the wireless communication device 820 further includes at least one external network interface coupled with the processing system that enables communication with a core network or backhaul network that enables the wireless communication device 820 to gain access to external networks including the Internet.

The wireless communication device 820 includes a pervious parameter component 825, a machine learning model component 830, an updated parameter component 835, an updated communications component 840, and an autoencoder component 845. Portions of one or more of the pervious parameter component 825, the machine learning model component 830, the updated parameter component 835, the updated communications component 840, and the autoencoder component 845 may be implemented at least in part in hardware or firmware. For example, one or more of the pervious parameter component 825, the machine learning model component 830, the updated parameter component 835, the updated communications component 840, and the autoencoder component 845 may be implemented at least in part by at least a processor or a modem. In some examples, portions of one or more of the pervious parameter component 825, the machine learning model component 830, the updated parameter component 835, the updated communications component 840, and the autoencoder component 845 may be implemented at least in part by a processor and software in the form of processor-executable code stored in memory.

The wireless communication device 820 may support wireless communications in accordance with examples as disclosed herein. The pervious parameter component 825 is configurable or configured to receive a first report from a second AP served by the first AP, the first report including a first set of multiple parameters associated with the second AP. The machine learning model component 830 is configurable or configured to input a set of multiple inputs including the first set of multiple parameters, a set of multiple current local parameters including a current configuration of the first AP, or both into an ML model. The updated parameter component 835 is configurable or configured to receive a set of multiple outputs of the machine learning model, the set of multiple outputs including a set of multiple updated local parameters for the first AP. The updated communications component 840 is configurable or configured to perform wireless communications with the second AP, a third AP that serves the first AP, one or more STAs, or any combination thereof, in accordance with the set of multiple updated local parameters for the first AP.

In some examples, the pervious parameter component 825 is configurable or configured to receive, from the third AP, a second report including a second set of multiple parameters associated with the third AP, where the set of multiple outputs of the machine learning model are based at least in part on the second set of multiple parameters and receive, from the third AP, an indication of a traffic pattern associated with the third AP, an indication of one or more performance metrics associated with a set of multiple previous parameters, or both, the traffic pattern based on the current configuration of the first AP. In some examples, the machine learning model component 830 is configurable or configured to apply a reward function based on the traffic pattern, the one or more performance metrics, a satisfaction of a target time threshold, or a combination thereof, where receiving the set of multiple updated local parameters is based on the reward function.

In some examples, the updated parameter component 835 is configurable or configured to output to the second AP, the third AP, or both, an updated configuration report including the set of multiple updated local parameters, an indication of one or more performance metrics associated with the set of multiple updated local parameters, or a combination thereof.

In some examples, the pervious parameter component 825 is configurable or configured to determine the set of multiple inputs to the machine learning model in accordance with the first set of multiple parameters, the second set of multiple parameters, the set of multiple current local parameters, or any combination thereof, where the set of multiple inputs includes one or more system topology parameters, one or more traffic parameters, one or more channel parameters, or any combination thereof, and where the set of multiple inputs to the machine learning model are associated with a mesh network including at least the first AP, the second AP, and the third AP.

In some examples, the pervious parameter component 825 is configurable or configured to encode the set of multiple inputs to the machine learning model according to one or more parameter types, where each input of the set of multiple inputs to the machine learning model are associated with a respective device identifier or traffic flow identifier corresponding to a network topology of the mesh network.

In some examples, the pervious parameter component 825 is configurable or configured to encode the set of multiple inputs to the machine learning model according to a network topology hierarchy mapping, where the set of multiple inputs to the machine learning model are associated with one or more hops of the mesh network, and where a relative position of the set of multiple inputs within the mesh network with respect to each other input of the set of multiple inputs is determined based on the network topology hierarchy mapping and the one or more hops of the mesh network.

In some examples, the one or more system topology parameters include a backhaul client association, a fronthaul client association, a pathloss value for each of the backhaul client association, the fronthaul client association, one or more interfering BSSs for each BSS of the mesh network, or any combination thereof.

In some examples, the one or more traffic parameters include a traffic demand per communication flow, a traffic direction per communication flow, an SLA per communication flow, a communication flow client association, or any combination thereof.

In some examples, the one or more channel parameters include one or more channel numbers for each AP multi-link device of the mesh network, a channel bandwidth for each BSS, a channel access delay for each BSS, an airtime of one or more overlapping BSSs for each BSS, or any combination thereof.

In some examples, the machine learning model component 830 is configurable or configured to generate a reward function output for the machine learning model based on a performance impact associated with a set of multiple previous outputs of the machine learning model, a satisfaction of a target time threshold, or both. In some examples, the machine learning model component 830 is configurable or configured to adjust one or more parameters for inputting into the machine learning model in accordance with the reward function output.

In some examples, the updated communications component 840 is configurable or configured to measure the performance impact based on applying the set of multiple updated local parameters, the performance impact associated with a performance of a mesh network including at least the first AP, the second AP, the third AP, and one or more STAs, where generating the reward function output is based on measuring the performance impact.

In some examples, the target time threshold includes a timing for determining, in accordance with the machine learning model, the set of multiple updated local parameters based on the inputting.

In some examples, the autoencoder component 845 is configurable or configured to input the first set of multiple parameters, the second set of multiple parameters, the set of multiple current local parameters, or any combination thereof into an autoencoder model. In some examples, the autoencoder component 845 is configurable or configured to receive an output of the autoencoder model including a set of multiple candidate local parameters. In some examples, the autoencoder component 845 is configurable or configured to compare the set of multiple candidate local parameters to the set of multiple updated local parameters.

In some examples, the updated parameter component 835 is configurable or configured to select the set of multiple updated local parameters instead of the set of multiple candidate local parameters based on an offset between the set of multiple candidate local parameters and the set of multiple updated local parameters satisfying a threshold according to the comparing.

In some examples, the pervious parameter component 825 is configurable or configured to sample a set of multiple candidate communication configurations corresponding to a set of multiple candidate outputs of the machine learning model for the first AP during a training stage for the machine learning model. In some examples, the pervious parameter component 825 is configurable or configured to select a subset of the set of multiple candidate communication configurations based on the sampling and based on one or more performance metrics corresponding to the set of multiple candidate communication configurations. In some examples, the machine learning model component 830 is configurable or configured to update the machine learning model in accordance with the subset of the set of multiple candidate communication configurations, where receiving the set of multiple updated local parameters is based on updating the machine learning model.

In some examples, the one or more performance metrics include a latency SLA, a throughput SLA, a data fairness associated with the first AP, a data capacity associated with the first AP, or any combination thereof.

FIG. 9 shows a flowchart illustrating an example process 900 performable by or at a first AP that supports artificial intelligence-based Wi-Fi mesh configuration. The operations of the process 900 may be implemented by a first AP or its components as described herein. For example, the process 900 may be performed by a wireless communication device, such as the wireless communication device 820 described with reference to FIG. 8, operating as or within a wireless AP. In some examples, the process 900 may be performed by a wireless AP, such as one of the APs 102 described with reference to FIG. 1.

In some examples, in 905, the first AP may a first report from a second AP served by the first AP, the first report including a first plurality of parameters associated with the second AP. The operations of 905 may be performed in accordance with examples as disclosed herein. In some implementations, aspects of the operations of 905 may be performed by a pervious parameter component 825 as described with reference to FIG. 8.

In some examples, in 910, the first AP may input a set of multiple inputs including the first set of multiple parameters, a set of multiple current local parameters including a current configuration of the first AP, or both into an ML model. The operations of 910 may be performed in accordance with examples as disclosed herein. In some implementations, aspects of the operations of 910 may be performed by a machine learning model component 830 as described with reference to FIG. 8.

In some examples, in 915, the first AP may receive a set of multiple outputs of the machine learning model, the set of multiple outputs including a set of multiple updated local parameters for the first AP. The operations of 915 may be performed in accordance with examples as disclosed herein. In some implementations, aspects of the operations of 915 may be performed by an updated parameter component 835 as described with reference to FIG. 8.

In some examples, in 920, the first AP may perform wireless communications with the second AP, a third AP that serves the first AP, one or more STAs, or any combination thereof, in accordance with the set of multiple updated local parameters for the first AP. The operations of 920 may be performed in accordance with examples as disclosed herein. In some implementations, aspects of the operations of 920 may be performed by an updated communications component 840 as described with reference to FIG. 8.

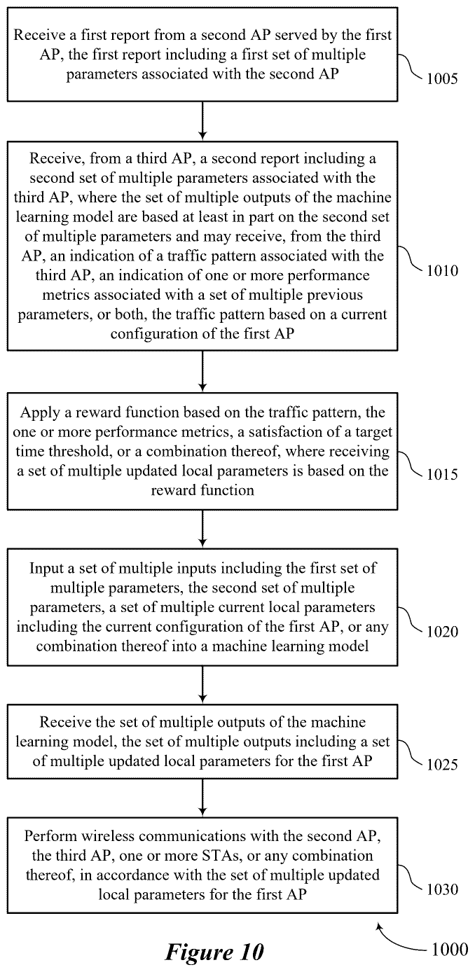

FIG. 10 shows a flowchart illustrating an example process 1000 performable by or at a first AP that supports artificial intelligence-based Wi-Fi mesh configuration. The operations of the process 1000 may be implemented by a first AP or its components as described herein. For example, the process 1000 may be performed by a wireless communication device, such as the wireless communication device 820 described with reference to FIG. 8, operating as or within a wireless AP. In some examples, the process 1000 may be performed by a wireless AP, such as one of the APs 102 described with reference to FIG. 1.

In some examples, in 1005, the first AP may receive a first report from a second AP served by the first AP, the first report including a first set of multiple parameters associated with the second AP. The operations of 1005 may be performed in accordance with examples as disclosed herein. In some implementations, aspects of the operations of 1005 may be performed by a pervious parameter component 825 as described with reference to FIG. 8.

In some examples, in 1010, the first AP may receive, from the third AP, a second report including a second set of multiple parameters associated with the third AP, where the set of multiple outputs of the machine learning model are based at least in part on the second set of multiple parameters and may receive, from the third AP, an indication of a traffic pattern associated with the third AP, an indication of one or more performance metrics associated with a set of multiple previous parameters, or both, the traffic pattern based on a current configuration of the first AP. The operations of 1010 may be performed in accordance with examples as disclosed herein. In some implementations, aspects of the operations of 1010 may be performed by a pervious parameter component 825 as described with reference to FIG. 8.

In some examples, in 1015, the first AP may apply a reward function based on the traffic pattern, the one or more performance metrics, a satisfaction of a target time threshold, or a combination thereof, where receiving a set of multiple updated local parameters is based on the reward function. The operations of 1015 may be performed in accordance with examples as disclosed herein. In some implementations, aspects of the operations of 1015 may be performed by a machine learning model component 830 as described with reference to FIG. 8.

In some examples, in 1020, the first AP may input a set of multiple inputs including the first set of multiple parameters, the second set of multiple parameters, a set of multiple current local parameters including the current configuration of the first AP, or any combination thereof into a machine learning model. The operations of 1020 may be performed in accordance with examples as disclosed herein. In some implementations, aspects of the operations of 1020 may be performed by a machine learning model component 830 as described with reference to FIG. 8.

In some examples, in 1025, the first AP may receive the set of multiple outputs of the machine learning model, the set of multiple outputs including a set of multiple updated local parameters for the first AP. The operations of 1025 may be performed in accordance with examples as disclosed herein. In some implementations, aspects of the operations of 1025 may be performed by an updated parameter component 835 as described with reference to FIG. 8.

In some examples, in 1030, the first AP may perform wireless communications with the second AP, the third AP, one or more STAs, or any combination thereof, in accordance with the set of multiple updated local parameters for the first AP. The operations of 1030 may be performed in accordance with examples as disclosed herein. In some implementations, aspects of the operations of 1030 may be performed by an updated communications component 840 as described with reference to FIG. 8.

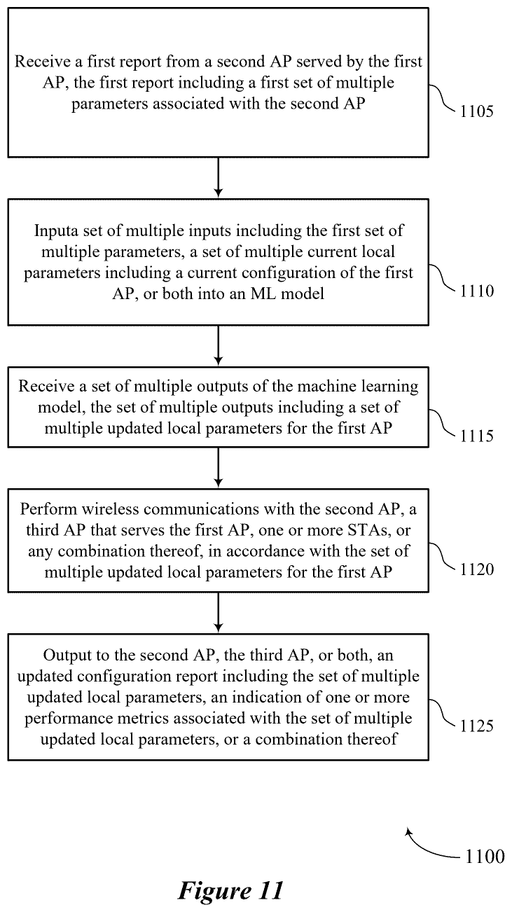

FIG. 11 shows a flowchart illustrating an example process 1100 performable by or at a first AP that supports artificial intelligence-based Wi-Fi mesh configuration. The operations of the process 1100 may be implemented by a first AP or its components as described herein. For example, the process 1100 may be performed by a wireless communication device, such as the wireless communication device 820 described with reference to FIG. 8, operating as or within a wireless AP. In some examples, the process 1100 may be performed by a wireless AP, such as one of the APs 102 described with reference to FIG. 1.

In some examples, in 1105, the first AP may receive a first report from a second AP served by the first AP, the first report including a first set of multiple parameters associated with the second AP. The operations of 1105 may be performed in accordance with examples as disclosed herein. In some implementations, aspects of the operations of 1105 may be performed by a pervious parameter component 825 as described with reference to FIG. 8.

In some examples, in 1110, the first AP may input a set of multiple inputs including the first set of multiple parameters, a set of multiple current local parameters including a current configuration of the first AP, or both into an ML model. The operations of 1110 may be performed in accordance with examples as disclosed herein. In some implementations, aspects of the operations of 1110 may be performed by a machine learning model component 830 as described with reference to FIG. 8.

In some examples, in 1115, the first AP may receive a set of multiple outputs of the machine learning model, the set of multiple outputs including a set of multiple updated local parameters for the first AP. The operations of 1115 may be performed in accordance with examples as disclosed herein. In some implementations, aspects of the operations of 1115 may be performed by an updated parameter component 835 as described with reference to FIG. 8.

In some examples, in 1120, the first AP may perform wireless communications with the second AP, a third AP that serves the first AP, one or more STAs, or any combination thereof, in accordance with the set of multiple updated local parameters for the first AP. The operations of 1120 may be performed in accordance with examples as disclosed herein. In some implementations, aspects of the operations of 1120 may be performed by an updated communications component 840 as described with reference to FIG. 8.

In some examples, in 1125, the first AP may output to the second AP, the third AP, or both, an updated configuration report including the set of multiple updated local parameters, an indication of one or more performance metrics associated with the set of multiple updated local parameters, or a combination thereof. The operations of 1125 may be performed in accordance with examples as disclosed herein. In some implementations, aspects of the operations of 1125 may be performed by an updated parameter component 835 as described with reference to FIG. 8.

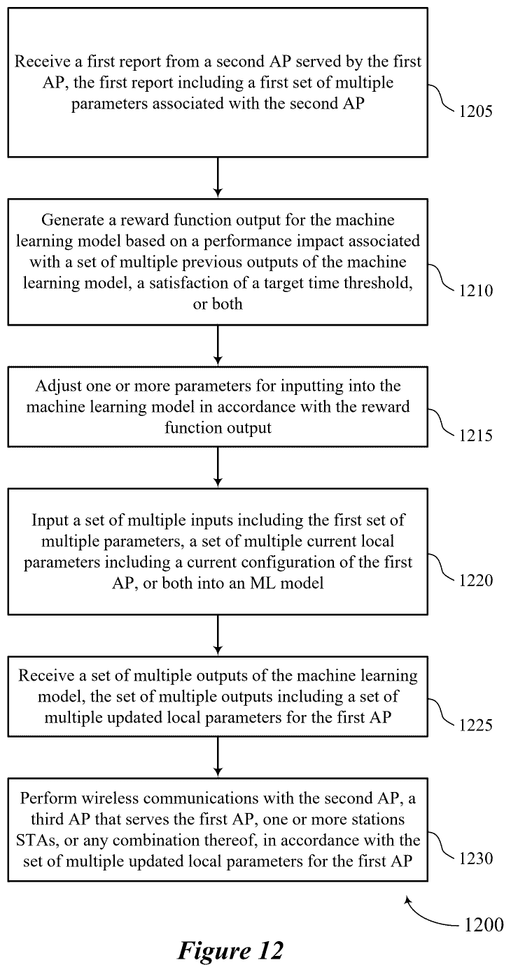

FIG. 12 shows a flowchart illustrating an example process 1200 performable by or at a first AP that supports artificial intelligence-based Wi-Fi mesh configuration. The operations of the process 1200 may be implemented by a first AP or its components as described herein. For example, the process 1200 may be performed by a wireless communication device, such as the wireless communication device 820 described with reference to FIG. 8, operating as or within a wireless AP. In some examples, the process 1200 may be performed by a wireless AP, such as one of the APs 102 described with reference to FIG. 1.

In some examples, in 1205, the first AP may receive a first report from a second AP served by the first AP, the first report including a first set of multiple parameters associated with the second AP. The operations of 1205 may be performed in accordance with examples as disclosed herein. In some implementations, aspects of the operations of 1205 may be performed by a pervious parameter component 825 as described with reference to FIG. 8.

In some examples, in 1210, the first AP may generate a reward function output for the machine learning model based on a performance impact associated with a set of multiple previous outputs of the machine learning model, a satisfaction of a target time threshold, or both. The operations of 1210 may be performed in accordance with examples as disclosed herein. In some implementations, aspects of the operations of 1210 may be performed by a machine learning model component 830 as described with reference to FIG. 8.

In some examples, in 1215, the first AP may adjust one or more parameters for inputting into the machine learning model in accordance with the reward function output. The operations of 1215 may be performed in accordance with examples as disclosed herein. In some implementations, aspects of the operations of 1215 may be performed by a machine learning model component 830 as described with reference to FIG. 8.

In some examples, in 1220, the first AP may input a set of multiple inputs including the first set of multiple parameters, a set of multiple current local parameters including a current configuration of the first AP, or both into an ML model. The operations of 1220 may be performed in accordance with examples as disclosed herein. In some implementations, aspects of the operations of 1220 may be performed by a machine learning model component 830 as described with reference to FIG. 8.

In some examples, in 1225, the first AP may receive a set of multiple outputs of the machine learning model, the set of multiple outputs including a set of multiple updated local parameters for the first AP. The operations of 1225 may be performed in accordance with examples as disclosed herein. In some implementations, aspects of the operations of 1225 may be performed by an updated parameter component 835 as described with reference to FIG. 8.

In some examples, in 1230, the first AP may perform wireless communications with the second AP, the third AP, one or more STAs, or any combination thereof, in accordance with the set of multiple updated local parameters for the first AP. The operations of 1230 may be performed in accordance with examples as disclosed herein. In some implementations, aspects of the operations of 1230 may be performed by an updated communications component 840 as described with reference to FIG. 8.

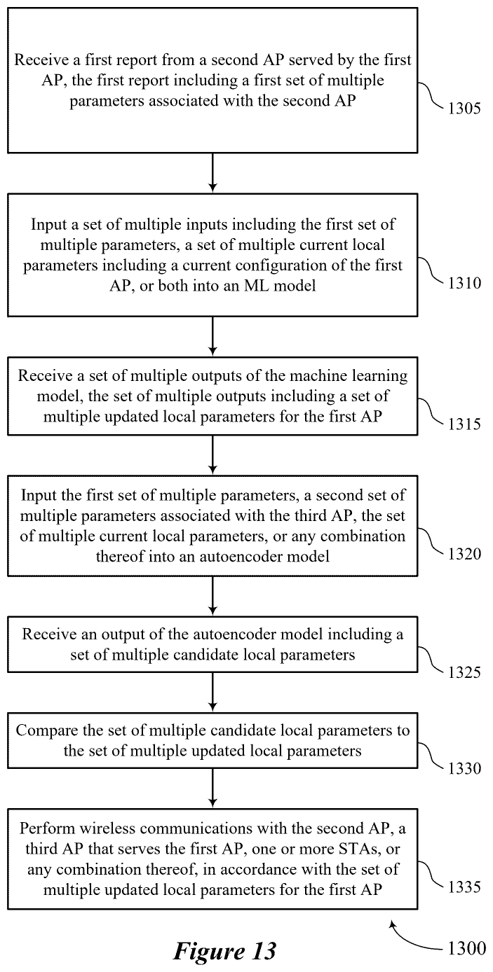

FIG. 13 shows a flowchart illustrating an example process 1300 performable by or at a first AP that supports artificial intelligence-based Wi-Fi mesh configuration. The operations of the process 1300 may be implemented by a first AP or its components as described herein. For example, the process 1300 may be performed by a wireless communication device, such as the wireless communication device 820 described with reference to FIG. 8, operating as or within a wireless AP. In some examples, the process 1300 may be performed by a wireless AP, such as one of the APs 102 described with reference to FIG. 1.

In some examples, in 1305, the first AP may receive a first report from a second AP served by the first AP, the first report including a first set of multiple parameters associated with the second AP. The operations of 1305 may be performed in accordance with examples as disclosed herein. In some implementations, aspects of the operations of 1305 may be performed by a pervious parameter component 825 as described with reference to FIG. 8.

In some examples, in 1310, the first AP may input a set of multiple inputs including the first set of multiple parameters, a set of multiple current local parameters including a current configuration of the first AP, or both into an ML model. The operations of 1310 may be performed in accordance with examples as disclosed herein. In some implementations, aspects of the operations of 1310 may be performed by a machine learning model component 830 as described with reference to FIG. 8.

In some examples, in 1315, the first AP may receive a set of multiple outputs of the machine learning model, the set of multiple outputs including a set of multiple updated local parameters for the first AP. The operations of 1315 may be performed in accordance with examples as disclosed herein. In some implementations, aspects of the operations of 1315 may be performed by an updated parameter component 835 as described with reference to FIG. 8.

In some examples, in 1320, the first AP may input the first set of multiple parameters, a second set of multiple parameters associated with the third AP, the set of multiple current local parameters, or any combination thereof into an autoencoder model. The operations of 1320 may be performed in accordance with examples as disclosed herein. In some implementations, aspects of the operations of 1320 may be performed by an autoencoder component 845 as described with reference to FIG. 8.

In some examples, in 1325, the first AP may receive an output of the autoencoder model including a set of multiple candidate local parameters. The operations of 1325 may be performed in accordance with examples as disclosed herein. In some implementations, aspects of the operations of 1325 may be performed by an autoencoder component 845 as described with reference to FIG. 8.

In some examples, in 1330, the first AP may compare the set of multiple candidate local parameters to the set of multiple updated local parameters. The operations of 1330 may be performed in accordance with examples as disclosed herein. In some implementations, aspects of the operations of 1330 may be performed by an autoencoder component 845 as described with reference to FIG. 8.

In some examples, in 1335, the first AP may perform wireless communications with the second AP, the third AP, one or more STAs, or any combination thereof, in accordance with the set of multiple updated local parameters for the first AP. The operations of 1335 may be performed in accordance with examples as disclosed herein. In some implementations, aspects of the operations of 1335 may be performed by an updated communications component 840 as described with reference to FIG. 8.

Implementation examples are described in the following numbered clauses:

The following provides an overview of aspects of the present disclosure:

Aspect 1: A method for wireless communications at a first AP, comprising: receiving a first report from a second AP served by the first AP, the first report comprising a first plurality of parameters associated with the second AP; inputting a plurality of inputs comprising the first plurality of parameters, a plurality of current local parameters comprising a current configuration of the first AP, or both into a machine learning model; receiving a plurality of outputs of the machine learning model, the plurality of outputs comprising a plurality of updated local parameters for the first AP; and performing wireless communications with the second AP, a third AP that serves the first AP, one or more STAs, or any combination thereof, in accordance with the plurality of updated local parameters for the first AP.

Aspect 2: The method of aspect 1, further comprising: receiving, from the third AP, a second report comprising a second plurality of parameters associated with the third AP, wherein the plurality of outputs of the machine learning model are based at least in part on the second plurality of parameters; receiving, from the third AP, an indication of a traffic pattern associated with the third AP, an indication of one or more performance metrics associated with a plurality of previous parameters, the traffic pattern based at least in part on the current configuration of the first AP; and applying a reward function based at least in part on the traffic pattern, or both, the one or more performance metrics, a satisfaction of a target time threshold, or a combination thereof, wherein receiving the plurality of updated local parameters is based at least in part on the reward function.

Aspect 3: The method of aspect 1, further comprising: outputting to the second AP, the third AP, or both, an updated configuration report comprising the plurality of updated local parameters, an indication of one or more performance metrics associated with the plurality of updated local parameters, or a combination thereof.

Aspect 4: The method of any of aspects 1 through 2, further comprising: determining the plurality of inputs to the machine learning model in accordance with the first plurality of parameters, the second plurality of parameters, the plurality of current local parameters, or any combination thereof, wherein the plurality of inputs includes one or more system topology parameters, one or more traffic parameters, one or more channel parameters, or any combination thereof, and wherein the plurality of inputs to the machine learning model are associated with a mesh network including at least the first AP, the second AP, and the third AP.

Aspect 5: The method of aspect 4, further comprising: encoding the plurality of inputs to the machine learning model according to one or more parameter types, wherein each input of the plurality of inputs to the machine learning model are associated with a respective device ID or traffic flow ID corresponding to a network topology of the mesh network.

Aspect 6: The method of aspect 4, further comprising: encoding the plurality of inputs to the machine learning model according to a network topology hierarchy mapping, wherein the plurality of inputs to the machine learning model are associated with one or more hops of the mesh network, and wherein a relative position of the plurality of inputs within the mesh network with respect to each other input of the plurality of inputs is determined based at least in part on the network topology hierarchy mapping and the one or more hops of the mesh network.

Aspect 7: The method of any of aspects 4 through 6, wherein the one or more system topology parameters include a backhaul client association, a fronthaul client association, a pathloss value for each of the backhaul client association, the fronthaul client association, one or more interfering BSSs for each BSS of the mesh network, or any combination thereof.

Aspect 8: The method of any of aspects 4 through 6, wherein the one or more traffic parameters include a traffic demand per communication flow, a traffic direction per communication flow, a SLA per communication flow, a communication flow client association, or any combination thereof.

Aspect 9: The method of any of aspects 4 through 6, wherein the one or more channel parameters include one or more channel numbers for each AP multi-link device of the mesh network, a channel bandwidth for each BSS, a channel access delay for each BSS, an airtime of one or more overlapping BSSs for each BSS, or any combination thereof.

Aspect 10: The method of any of aspects 1 through 2, further comprising: generating a reward function output for the machine learning model based at least in part on a performance impact associated with a plurality of previous outputs of the machine learning model, a satisfaction of a target time threshold, or both; and adjusting one or more parameters for inputting into the machine learning model in accordance with the reward function output.

Aspect 11: The method of aspect 10, further comprising: measuring the performance impact based at least in part on applying the plurality of updated local parameters, the performance impact associated with a performance of a mesh network including at least the first AP, the second AP, the third AP, and one or more STAs, wherein generating the reward function output is based at least in part on measuring the performance impact.

Aspect 12: The method of any of aspects 10 through 11, wherein the target time threshold comprises a timing for determining, in accordance with the machine learning model, the plurality of updated local parameters based at least in part on the inputting.

Aspect 13: The method of any of aspects 1 through 2, further comprising: inputting the first plurality of parameters, a second plurality of parameters associated with the third AP, the plurality of current local parameters, or any combination thereof into an autoencoder model; receiving an output of the autoencoder model comprising a plurality of candidate local parameters; and comparing the plurality of candidate local parameters to the plurality of updated local parameters.

Aspect 14: The method of aspect 13, further comprising: selecting the plurality of updated local parameters instead of the plurality of candidate local parameters based at least in part on an offset between the plurality of candidate local parameters and the plurality of updated local parameters satisfying a threshold according to the comparing.

Aspect 15: The method of any of aspects 1 through 4, further comprising: sampling a plurality of candidate communication configurations corresponding to a plurality of candidate outputs of the machine learning model for the first AP during a training stage for the machine learning model; selecting a subset of the plurality of candidate communication configurations based at least in part on the sampling and based at least in part on one or more performance metrics corresponding to the plurality of candidate communication configurations; and updating the machine learning model in accordance with the subset of the plurality of candidate communication configurations, wherein receiving the plurality of updated local parameters is based at least in part on updating the machine learning model.

Aspect 16: The method of aspect 15, wherein the one or more performance metrics comprise a latency SLA, a throughput SLA, a data fairness associated with the first AP, a data capacity associated with the first AP, or any combination thereof.

Aspect 17: A first AP for wireless communications, comprising one or more memories storing processor-executable code, and one or more processors coupled with the one or more memories and individually or collectively operable to execute the code to cause the first AP to perform a method of any of aspects 1 through 16.

Aspect 18: A first AP for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
receive a first report from a second AP served by the first AP, the first report comprising a first plurality of parameters associated with the second AP;
input a plurality of inputs comprising the first plurality of parameters, a plurality of current local parameters comprising a current configuration of the first AP, or both into a machine learning model;
receive a plurality of outputs of the machine learning model, the plurality of outputs comprising a plurality of updated local parameters for the first AP; and
perform wireless communications with the second AP, a third AP that serves the first AP, one or more stations (STAs), or any combination thereof, in accordance with the plurality of updated local parameters for the first AP.

2. The first AP of claim 1, wherein the processing system is further configured to cause the first AP to:
receive, from the third AP, a second report comprising a second plurality of parameters associated with the third AP, wherein the plurality of outputs of the machine learning model are based at least in part on the second plurality of parameters;
receive, from the third AP, an indication of a traffic pattern associated with the third AP, an indication of one or more performance metrics associated with a plurality of previous parameters, or both, the traffic pattern based at least in part on the current configuration of the first AP; and
apply a reward function based at least in part on the traffic pattern, the one or more performance metrics, a satisfaction of a target time threshold, or a combination thereof, wherein receiving the plurality of updated local parameters is based at least in part on the reward function.

3. The first AP of claim 1, wherein the processing system is further configured to cause the first AP to:
output to the second AP, the third AP, or both, an updated configuration report comprising the plurality of updated local parameters, an indication of one or more performance metrics associated with the plurality of updated local parameters, or a combination thereof.

4. The first AP of claim 1, wherein the processing system is further configured to cause the first AP to:
determine the plurality of inputs to the machine learning model in accordance with the first plurality of parameters, the second plurality of parameters, the plurality of current local parameters, or any combination thereof, wherein the plurality of inputs includes one or more system topology parameters, one or more traffic parameters, one or more channel parameters, or any combination thereof, and wherein the plurality of inputs to the machine learning model are associated with a mesh network including at least the first AP, the second AP, and the third AP.

5. The first AP of claim 4, wherein the processing system is further configured to cause the first AP to:
encode the plurality of inputs to the machine learning model according to one or more parameter types, wherein each input of the plurality of inputs to the machine learning model are associated with a respective device identifier or traffic flow identifier corresponding to a network topology of the mesh network.

6. The first AP of claim 4, wherein the processing system is further configured to cause the first AP to:
encode the plurality of inputs to the machine learning model according to a network topology hierarchy mapping, wherein the plurality of inputs to the machine learning model are associated with one or more hops of the mesh network, and wherein a relative position of the plurality of inputs within the mesh network with respect to each other input of the plurality of inputs is determined based at least in part on the network topology hierarchy mapping and the one or more hops of the mesh network.

7. The first AP of claim 4, wherein the one or more system topology parameters include a backhaul client association, a fronthaul client association, a pathloss value for each of the backhaul client association, the fronthaul client association, one or more interfering basic service sets for each basic service set of the mesh network, or any combination thereof.

8. The first AP of claim 4, wherein the one or more traffic parameters include a traffic demand per communication flow, a traffic direction per communication flow, a service level agreement per communication flow, a communication flow client association, or any combination thereof.

9. The first AP of claim 4, wherein the one or more channel parameters include one or more channel numbers for each AP multi-link device of the mesh network, a channel bandwidth for each basic service set, a channel access delay for each basic service set, an airtime of one or more overlapping basic service sets for each basic service set, or any combination thereof.

10. The first AP of claim 1, wherein the processing system is further configured to cause the first AP to:
generate a reward function output for the machine learning model based at least in part on a performance impact associated with a plurality of previous outputs of the machine learning model, a satisfaction of a target time threshold, or both; and
adjust one or more parameters for inputting into the machine learning model in accordance with the reward function output.

11. The first AP of claim 10, wherein the processing system is further configured to cause the first AP to:
measure the performance impact based at least in part on applying the plurality of updated local parameters, the performance impact associated with a performance of a mesh network including at least the first AP, the second AP, the third AP, and one or more STAs, wherein generating the reward function output is based at least in part on measuring the performance impact.

12. The first AP of claim 10, wherein the target time threshold comprises a timing for determining, in accordance with the machine learning model, the plurality of updated local parameters based at least in part on the inputting.

13. The first AP of claim 1, wherein the processing system is further configured to cause the first AP to:
input the first plurality of parameters, a second plurality of parameters associated with the third AP, the plurality of current local parameters, or any combination thereof into an autoencoder model;
receive an output of the autoencoder model comprising a plurality of candidate local parameters; and
compare the plurality of candidate local parameters to the plurality of updated local parameters.

14. The first AP of claim 13, wherein the processing system is further configured to cause the first AP to:
select the plurality of updated local parameters instead of the plurality of candidate local parameters based at least in part on an offset between the plurality of candidate local parameters and the plurality of updated local parameters satisfying a threshold according to the comparing.

15. The first AP of claim 1, wherein the processing system is further configured to cause the first AP to:
sample a plurality of candidate communication configurations corresponding to a plurality of candidate outputs of the machine learning model for the first AP during a training stage for the machine learning model;
select a subset of the plurality of candidate communication configurations based at least in part on the sampling and based at least in part on one or more performance metrics corresponding to the plurality of candidate communication configurations; and
update the machine learning model in accordance with the subset of the plurality of candidate communication configurations, wherein receiving the plurality of updated local parameters is based at least in part on updating the machine learning model.

16. The first AP of claim 15, wherein the one or more performance metrics comprise a latency service level agreement, a throughput service level agreement, a data fairness associated with the first AP, a data capacity associated with the first AP, or any combination thereof.

17. A method for wireless communications at a first access point (AP), comprising:
receiving a first report from a second AP served by the first AP, the first report comprising a first plurality of parameters associated with the second AP;
inputting a plurality of inputs comprising the first plurality of parameters, a plurality of current local parameters comprising a current configuration of the first AP, or both into a machine learning model;
receiving a plurality of outputs of the machine learning model, the plurality of outputs comprising a plurality of updated local parameters for the first AP; and
performing wireless communications with the second AP, a third AP that serves the first AP, one or more stations (STAs), or any combination thereof, in accordance with the plurality of updated local parameters for the first AP.

18. The method of claim 17, further comprising:
receiving, from the third AP, a second report comprising a second plurality of parameters associated with the third AP, wherein the plurality of outputs of the machine learning model are based at least in part on the second plurality of parameters;
receiving, from the third AP, an indication of a traffic pattern associated with the third AP, an indication of one or more performance metrics associated with a plurality of previous parameters, or both, the traffic pattern based at least in part on the current configuration of the first AP; and
applying a reward function based at least in part on the traffic pattern, the one or more performance metrics, a satisfaction of a target time threshold, or a combination thereof, wherein receiving the plurality of updated local parameters is based at least in part on the reward function.

19. The method of claim 17, further comprising:
outputting to the second AP, the third AP, or both, an updated configuration report comprising the plurality of updated local parameters, an indication of one or more performance metrics associated with the plurality of updated local parameters, or a combination thereof.

20. The method of claim 17, further comprising:
determining the plurality of inputs to the machine learning model in accordance with the first plurality of parameters, the second plurality of parameters, the plurality of current local parameters, or any combination thereof, wherein the plurality of inputs includes one or more system topology parameters, one or more traffic parameters, one or more channel parameters, or any combination thereof, and wherein the plurality of inputs to the machine learning model are associated with a mesh network including at least the first AP, the second AP, and the third AP.

21. The method of claim 20, further comprising:
encoding the plurality of inputs to the machine learning model according to one or more parameter types, wherein each input of the plurality of inputs to the machine learning model are associated with a respective device identifier or traffic flow identifier corresponding to a network topology of the mesh network.

22. The method of claim 20, further comprising:
encoding the plurality of inputs to the machine learning model according to a network topology hierarchy mapping, wherein the plurality of inputs to the machine learning model are associated with one or more hops of the mesh network, and wherein a relative position of the plurality of inputs within the mesh network with respect to each other input of the plurality of inputs is determined based at least in part on the network topology hierarchy mapping and the one or more hops of the mesh network.

23. The method of claim 17, further comprising:
generating a reward function output for the machine learning model based at least in part on a performance impact associated with a plurality of previous outputs of the machine learning model, a satisfaction of a target time threshold, or both; and
adjusting one or more parameters for inputting into the machine learning model in accordance with the reward function output.

24. The method of claim 23, further comprising:
measuring the performance impact based at least in part on applying the plurality of updated local parameters, the performance impact associated with a performance of a mesh network including at least the first AP, the second AP, the third AP, and one or more STAs, wherein generating the reward function output is based at least in part on measuring the performance impact.

25. The method of claim 23, wherein the target time threshold comprises a timing for determining, in accordance with the machine learning model, the plurality of updated local parameters based at least in part on the inputting.

26. The method of claim 17, further comprising:
inputting the first plurality of parameters, the second plurality of parameters, the plurality of current local parameters, or any combination thereof into an autoencoder model;
receiving an output of the autoencoder model comprising a plurality of candidate local parameters; and
comparing the plurality of candidate local parameters to the plurality of updated local parameters.

27. The method of claim 26, further comprising:
selecting the plurality of updated local parameters instead of the plurality of candidate local parameters based at least in part on an offset between the plurality of candidate local parameters and the plurality of updated local parameters satisfying a threshold according to the comparing.

28. The method of claim 17, further comprising:
sampling a plurality of candidate communication configurations corresponding to a plurality of candidate outputs of the machine learning model for the first AP during a training stage for the machine learning model;
selecting a subset of the plurality of candidate communication configurations based at least in part on the sampling and based at least in part on one or more performance metrics corresponding to the plurality of candidate communication configurations; and
updating the machine learning model in accordance with the subset of the plurality of candidate communication configurations, wherein receiving the plurality of updated local parameters is based at least in part on updating the machine learning model.

29. A first access point (AP), comprising:
one or more memories storing processor-executable code; and
one or more processors coupled with the one or more memories and individually or collectively operable to execute the code to cause the first AP to:
receive a first report from a second AP served by the first AP, the first report comprising a first plurality of parameters associated with the second AP;
input a plurality of inputs comprising the first plurality of parameters, a plurality of current local parameters comprising a current configuration of the first AP, or both into a machine learning model;
receive a plurality of outputs of the machine learning model, the plurality of outputs comprising a plurality of updated local parameters for the first AP; and
perform wireless communications with the second AP, a third AP that serves the first AP, one or more stations (STAs), or any combination thereof, in accordance with the plurality of updated local parameters for the first AP.

30. A non-transitory computer-readable medium storing code for wireless communications at a first access point (AP), the code comprising instructions executable by one or more processors to:
receive a first report from a second AP served by the first AP, the first report comprising a first plurality of parameters associated with the second AP;
input a plurality of inputs comprising the first plurality of parameters, a plurality of current local parameters comprising a current configuration of the first AP, or both into a machine learning model;
receive a plurality of outputs of the machine learning model, the plurality of outputs comprising a plurality of updated local parameters for the first AP; and
perform wireless communications with the second AP, a third AP that serves the first AP, one or more stations (STAs), or any combination thereof, in accordance with the plurality of updated local parameters for the first AP.
